(19) United States
(12) Patent Application Publication
(10) Pub. No.: US 2002/0174050 A1
(43) Pub. Date: Nov. 21, 2002

(54) Business capacity transaction management system

(76) Inventors: James Eynard, Chandler, AZ (US); Hongliang Philip Liu, Phoenix, AZ (US)

Correspondence Address: SQUIRE, SANDERS & DEMPSEY L.L.P., Two Renaissance Square, Suite 2700, 40 North Central Avenue, Phoenix, AZ, 85004-4498, US

(21) Appl. No.: 09/748,909

(22) Filed: Dec. 27, 2000

(51) Int. Cl. G06F 17/60

(52) U.S. Cl. 705/37

(57) ABSTRACT

A business transaction capacity management system provides an exchange for dynamically defined services to be exchanged among parties that have met standards imposed upon themselves. The system provides controls for reducing the risk of participating in a project and for limiting participation to buyers and sellers that meet criteria that are recognized in a trading community. The system facilitates the description of new goods and/or services being offered for exchange in terms developed by a trading community that are recognized in that trading community as commercially reasonable and facilitates user-defined qualifications for various limits to bring about further or different cooperation among the system's users.

### FIELD OF THE INVENTION

Embodiments of the present invention relate to the exchange of business services, for example, competitive trading units of a capacity to perform a manufacturing operation according to various criteria such as, inter alia, date, rate of production, quality controls, cost, and risk.

### BACKGROUND OF THE INVENTION

Conventional transaction systems for goods and services that are based on networked computer information technology, including Internet based auctions, contemplate isolated transactions, for example, the purchase of a consumer good such as a television set where the buyer is the end user. Such systems may involve businesses as buyers of goods (e.g., office supplies) or services (e.g., travel). Business transactions familiar to the original equipment manufacturer (OEM) are in many cases more complex than can be managed using isolated auction transactions.

Automated freight route planning double auctions have been suggested so that several shippers may participate in a route, each having won a price competition for specified services that match shipping requirements. Offers to buy include fixed-form detailed service requirements and offers to sell include fixed-form detailed service specifications.

A system for facilitating intraorganizational cooperation has been suggested. In such a system, a commodity (knowledge or labor) may be registered to be managed when a fixed criteria is met, specifically, when the amount of (or cost of) labor associated with the commodity exceeds a limit value.

A system for decision support has been suggested to assist a person who is able to trade excess future manufacturing capacity and thereby establish a course of action for manufacturing a desired product. The course of action may be optimal (e.g., lowest impact on schedules and inventory of the user or the supplying manufacturer) or edited to reflect non-quantified business concerns. The description of manufacturing capacity is only derived from available orders (offers to buy) and available capacity (offers to sell capacity) apparently prepared without knowledge of what types of information may be desirable or useful in operation of the decision support system.

These prior systems separately or in combination fail, inter alia, to provide controls for reducing the risk of participating in a project that may rely on future services (e.g., manufacturing capacity) from one or more suppliers. None of these prior systems provide controls for limiting participation to buyers and sellers that meet criteria recognized in the community as commercially reasonable expectations (e.g., technical experience, financial capacity, track record). None of the prior systems facilitate the description of new services being offered for exchange in new terms recognized in the community as commercially reasonable. User registration qualifications, product and service attributes to be described, and limit criteria are all fixed in these prior systems as defined at the time such a system is installed. This lack of flexibility prevents, for example, the formation and operation of a dynamic world-wide exchange using networked computer information technology. Such an exchange for dynamically defined services to be exchanged among parties that have met standards imposed upon themselves may have dramatic positive effects on the world economies.

Without methods and systems according to various aspects of the present invention, benefits may not be realized that may be significant to consumers (e.g., lower product prices, wider product selection, and/or better availability) and significant to major economies (e.g., greater gross national product, better use of labor, and/or narrower price variations for products and services).

### SUMMARY OF THE INVENTION

Systems and methods according to various aspects of the present invention provide one or more of the following functions in any combination: (a) providing controls for reducing the risk of participating in a project when that project may rely on future services from one or more suppliers; (b) providing controls for limiting participation to buyers and sellers that meet criteria that are recognized in a trading community (e.g. an industry or trading group) as commercially reasonable expectations; (c) facilitating the description of new goods and/or services being offered for exchange in terms developed by a trading community that are recognized in that trading community as commercially reasonable; (d) facilitating user-defined qualifications for user registration, product and service attribute descriptions, criteria for various limits imposed by the system, and criteria for thresholds used by the system to bring about further or different cooperation among the system's users (e.g., a trading community); and (e) hosting with networked computer information technology a world-wide exchange of dynamically defined services among parties that have, as a group, met standards defined and imposed upon themselves.

### BRIEF DESCRIPTION OF THE DRAWING

Embodiments of the present invention will now be further described with reference to the drawing, wherein like designations denote like elements, and:

FIG. 1 is a functional block diagram of a business capacity transaction management system according to various aspects of the present invention;

FIG. 2 is a data flow diagram of a client suitable for use in the system of FIG. 1;

FIG. 3A shows the arrangement of FIGS. 3B, 3C, and 3D;

FIG. 3B, 3C, and 3D form a data flow diagram of a server suitable for use in the system of FIG. 1;

FIG. 4 is a message sequence diagram of registration functions performed by the system of FIG. 1;

FIG. 5 is a message sequence diagram of group formation functions performed by the system of FIG. 1; and

FIG. 6 is a message sequence diagram of project functions performed by the system of FIG. 1.

### DETAILED DESCRIPTION OF THE PREFERRED EMBODIMENT

A business capacity includes the capability of a supplier to perform a service for a buyer. The service may include any commercially valuable service such as freight hauling, delivery of a product, manufacture of a product or a component to be used in another product, research and development, analysis of information or materials, repair and maintenance, advertising, forming a financial relationship, etc. The object of the business capacity may itself be an integrated service such as a capacity to deliver a product may include manufacture of all components and assembly of the product for delivery. The object of the business capacity may be a part of the business of the buyer, such as the manufacture of a component for a product that the buyer (e.g., an OEM) will assemble and market.

A business capacity transaction includes any commercial arrangement between a supplier and a customer. For example, when the capacity is a cold-roll steel mill which is available for use during a particular one month period, the transaction may be sale of a custom cold-roll steel product produced by the current owner/operator of the mill or lease of the mill to a middle man who finds operators and customers for the capacity. The transaction may or may not include a written agreement. When a written agreement is used in the closing of a business capacity transaction, the agreement may be a commodity futures contract, an option purchase agreement, a purchase order, a sales order, a distribution agreement, etc.

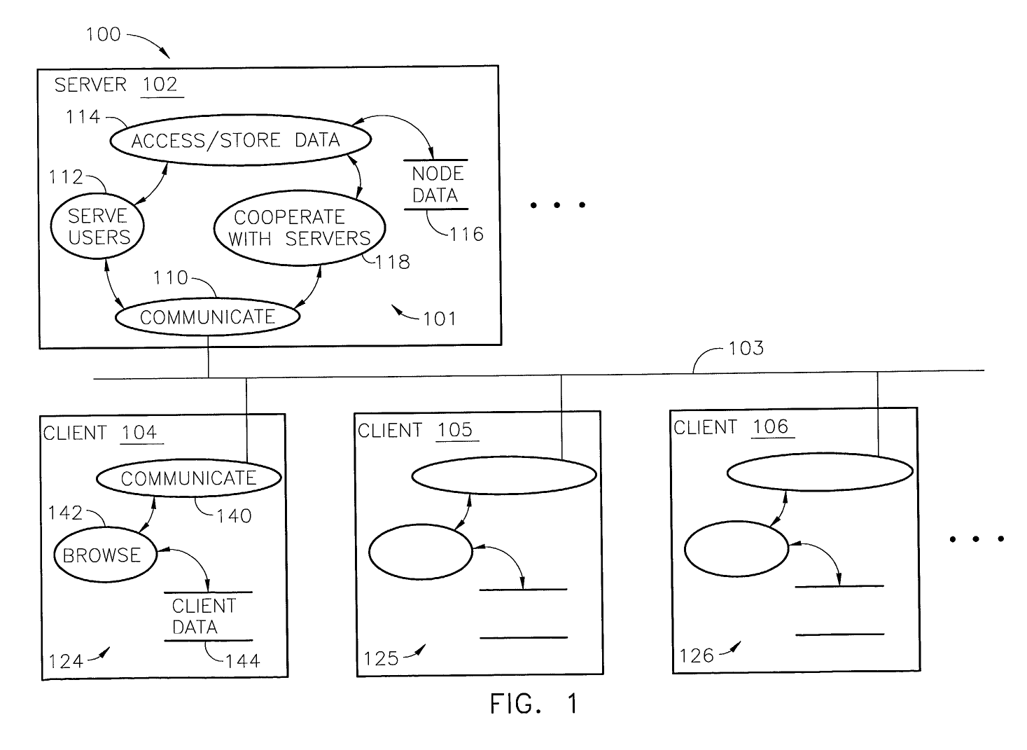

A business capacity transaction management (BCTM) system of the present invention may include hardware and software and suitably implements several networked computer information technologies. Networked computer information technologies include, inter alia, the technologies for programmable computers (e.g., architecture, circuits, memory and caching, bus sharing, processor instruction sets, etc.), operating systems (e.g., multitasking, interprocess communication, shadowed storage, etc.), database management systems (e.g., query languages, physical schemes for efficient file and record searching and retrieval), and network management (e.g., protocols of the type described by the Open Systems Interconnection (OSI) model, packet switching, routing, distributed storage arrangements, object request brokering, server architectures, etc.). A computer system according to various aspects of the present invention includes any suitable combination of these technologies (e.g., a conventional corporate intranet providing access to the Internet and to portable computers via wireless network links) programmed to perform methods as discussed below. For example, system 100 of FIG. 1 includes server 102 (representing any number of servers), network 103 (representing any logical or physical topology), and clients 104, 105, and 106 (representing any number of clients).

A server provides computing capability, access to peripherals, access to data stored or managed by software on the server, and access to other servers and other networks. For example, server 102 includes any conventional computer with suitable operating system (e.g., Microsoft Windows NT, or Linux) and communication and data management software for operation on a conventional network (e.g., a LAN, WAN, dialup, wireless or combination thereof). Server 102 represents one or more servers that individually (e.g., stand alone or redundantly) or collectively (e.g., as a conventional distributed processing application program) perform a collection of processes called the business capacity transaction management software (BCTMS). In one implementation BCTMS 101 includes Communicate process 110, Serve-users process 112, Access/store-data process 114, database 116 for node data, and Cooperate-with-servers process 118.

A client includes a computer system capable of communication with a server for presenting information stored on the server to a user of the client computer system (hereinafter, the “user” which may be a human, an automated process running on the client computer, or both) and for accepting information from the user to specify and perform one or more business capacity transactions. For example, clients 104, 105, and 106 include any conventional computer system for office or personal use such as a personal computer, palm-top computer, or network appliance with conventional memory (e.g., RAM, disk, or tape) and peripherals (e.g., document scanner, printer, and/or network interface). Software operative on the client includes any conventional operating system (e.g., Microsoft Windows, or Linux), a graphical user interface (GUI), and application specific user software such as software 124 that cooperates with BCTMS 101. User software 124 may include Communicate process 140, Browse process 142, and client data 144.

A network includes any medium supporting communication between servers and clients. Communication may be point-to-point or broadcast among any number of nodes (e.g., servers and/or clients) of the network. For example, network 103 may include an intranet, the Internet, the World Wide Web, and wireless links. Connection, activation, and data exchange may be dedicated, dial-up, client-initiated (pull), or server-initiated (push) at any suitable level of protocol.

Communicate process 110 of server 102 performs, inter alia, conventional operating system and conventional network communication functions for several protocols (e.g., SNMP, SMTP, TCP/IP, CORBA, DCOM, and FTP).

Serve-users process 112 facilitates any number of simultaneous sessions by clients 104, 105, and 106. Serve-users process 112 receives input and provides output to Communicate process 110 to interact with one or more users. Each session may be accomplished independent in time of other sessions and may access, read, revise, delete, combine, link, and write data or be provided with notifications so as to complete prerequisites (e.g., client answers other client's inquiry, client answers an inquiry made by BCTMS 101, client provides information, client provides authorization, and/or client indicates completion of events not monitored by BCTMS 101).

Access/store-data process 114 may include any conventional database management subsystem suitably programmed to manage node data stored in database 116 for the operations discussed above. Access/store-data process 114 receives data, status, and commands from Serve-users process 112 and provides data, status, processing results, and software to Serve-users process 112 as directed by commands or by automatic operations of BCTMS 101 (e.g., notification of a prerequisite completed as a consequence of an otherwise unrelated session). Node data includes, inter alia, information for the management of business capacity transactions; information (and formatting) for presentation to users during sessions; and software for performance by server 102, or clients 104, 105, and 106. Privileges for access, modification, and adding to node data 116 control operation of Access/store-data process 114. These privileges are stored in node data 116 and are associated to users (e.g., individually or by groups) by a system manager (a user having suitable privileges), by automatic operations of BCTMS 101 (e.g., by satisfaction of a prerequisite, for example, completing an agreement may permit access to proprietary information of a particular entity). Access may be in accordance with any conventional query language.

Node data 116 includes any conventional memory (e.g., RAM, disk, or tape) at any suitable physical location (e.g., central location, redundant sites, or off-line backup and archival sites). Node data 116 may be organized under any conventional file system supported by the operating system of one or more servers 102. For data management and reliability, all access to node data 116 may be via functions of Access/store-data process 114. Preferably, at least a portion of node data 116 is stored in accordance with extensible markup language (XML).

Cooperate-with-servers process 118 performs, inter alia, conventional functions for operations, software, and system reliability (e.g., maintaining sessions with fall back and soft fail techniques, software version control and automatic updating, software configuration management, and redundant and distributed data storage). Cooperate-with-servers process 118 gains access (e.g., query, create, read, write, modify, append, delete) to node data 116 via Access/store-data process 114. Cooperation may include transfer via Communicate process 110 of objects, status, commands, messages, data, software, and files over network 103 to other servers coupled to network 103.

Communicate process 140 in each client performs, inter alia, conventional operating system and conventional network communication functions for several protocols (e.g., SNMP, SMTP, TCP/IP, CORBA, DCOM, and FTP).

A browse process may at any time and from time to time be logically coupled to one or more Serve-users processes 112 in any number of servers for command/reply scenarios, information transfer, or notification (e.g., conventional ICQ technology). For example, Browse process 142 receives information, software (e.g., applets, classes, XML dictionaries), files, objects, forms, and data from network 103 (from any server 102) and supports a GUI for presenting information (including graphics and animations) to the user. Storage of items received may be accomplished by Browse process 142 in client data 144. Browse process 142 receives information from the user (i.e., any conventional input including selections, commands, keyboard input, voice or camera input, scanner input), from the operating system of client 104, and from client data 144 and may send this information (i.e., provide a copy) via Communicate process 140 to any server 102. Browse process 142 may include any conventional browser, for example, Netscape Navigator, America On-Line AOL browser, Microsoft Internet Explorer, etc.

Client data includes any information (e.g., software and/or data) suitable for assisting a business capacity transaction. For example client data 144 may include temporary files used for information presentation, permanent files for software that performs routine operations assisting the transaction (e.g., an agent, a daemon, a local ICQ program, an out-of-the-office notification agent, or a plug-in for alternate browser capabilities). Client data may include configuration information unique to client 104 or unique to the one or more users of client 104. Client data includes any conventional memory (e.g., RAM, disk, or tape) and may be stored on one or more devices (e.g., redundant drives, sites, or off-line backup and archival sites). Client data 104 may be organized under any conventional file system supported by the client operating system. Preferably, at least a portion of client data 104 is managed in accordance with extensible markup language (XML).

Clients 105 and 106 perform capabilities as described above for client 104. Different users of different clients may operate user software in different ways, causing the user software on one client to have a different configuration than user software on another client even though such user software may have originally been identical. User software 124, 125, and 126 each perform the functions described above and yet may be different due to differences in platforms (client 104 and 105 may have different computing circuits and/or peripherals) or differences in the manner in which the user software has been configured or used. Therefore, although it is preferred that any user may use any client for any operation of system 100, some clients may not immediately be configured for a particular operation without additional intermediate set up steps. Nevertheless, platform independent operation of any client by any user may be accomplished according to various aspects of the present invention.

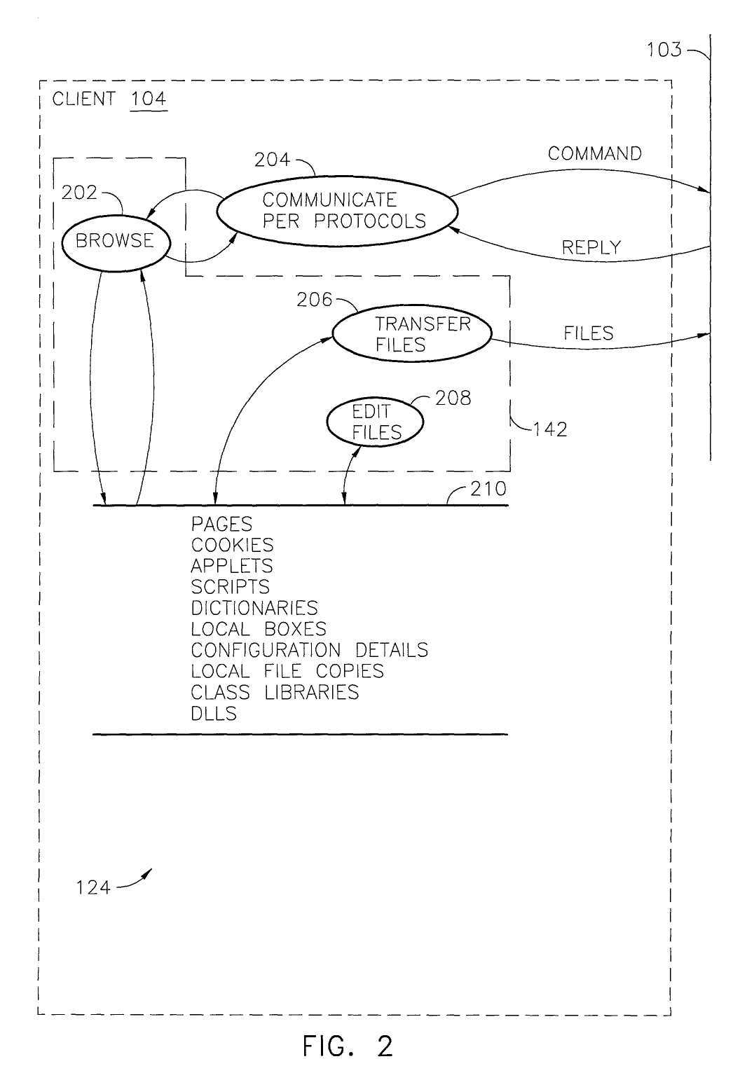

Client 104 (representative of any client of system 100) may be implemented according to the functional block diagram of FIG. 2. Client 104, of FIG. 2, includes user software 124 having Browse process 202, Communicate-per-protocols process 204, Transfer-files process 206, Edit-files process 208, and user data 210. Browse process 202 and Communicate process 204 include all functions as described above with reference to Browse process 142 and Communicate process 140. Commands provided to network 103 by Communicate process 204 may conform to one or more protocols, preferably HTTP and TCP/IP for operation on the Internet. Replies received from network 103 may conform to any protocol (and may be initiated by any client or server in the absence of a command from process 204, e.g., a probe or notification). Replies preferably conform to XML and/or HTML and may have embedded software to be interpreted, referenced, or performed by client 104 (e.g., an applet, script, class library, DTD, DLL, or EXE written in JAVA, PEARL, data, or executable code). Some or all client functions may be performed by one or more automated processes (e.g., for user-defmed scheduled or threshold-activated interactions), not shown; and, may be implemented using conventional application program interface (API) technologies.

Transfer-files process 206 may perform file transfers in whole or in part (e.g., streaming audio or video) for use on-line or off-line. Any conventional protocol may be used for file transfer. File transfer capabilities may be included as a plug-in to Browse process 202 or integrated into Browse process 202 or Communicate process 204. Access to files in user data 210 (e.g., create, read, write, modify, delete, execute) may be provided to Transfer-files process 206 directly by the client operating system or via Browse process 202.

Edit-files process 208 allows BCTMS 101, Browse process 202, or the user to create, read, write, modify, append to, or delete any portion of user data 210. Edit-files process may be implemented as an integrated editor of many file types described below with reference to user data 210, may be integrated with Browse process 202, or may be provided as a suite of independent editor programs.

User data 210 (corresponding in full or in part to client data 144) may include any conventional structures, for example, pages (cached in XML or HTML), cookies (e.g., saving configuration or preference information between sessions), applets, scripts, dictionaries (e.g., XML DTDs), local boxes for email and other messaging functions, configuration details (e.g., .INI files), local file copies (e.g., downloaded information to be used off-line), class libraries (e.g., for use by a JAVA interpreter in performing an applet), and DLLs (e.g., objects that may be brokered using DCOM). The structure and functions of user data 210 and related portions of BCTMS 101 are of the type described in “Webmaster in a Nutshell” by Stephen Spainhour and Valerie Quercia, published by O'Reilly and incorporated herein by reference.

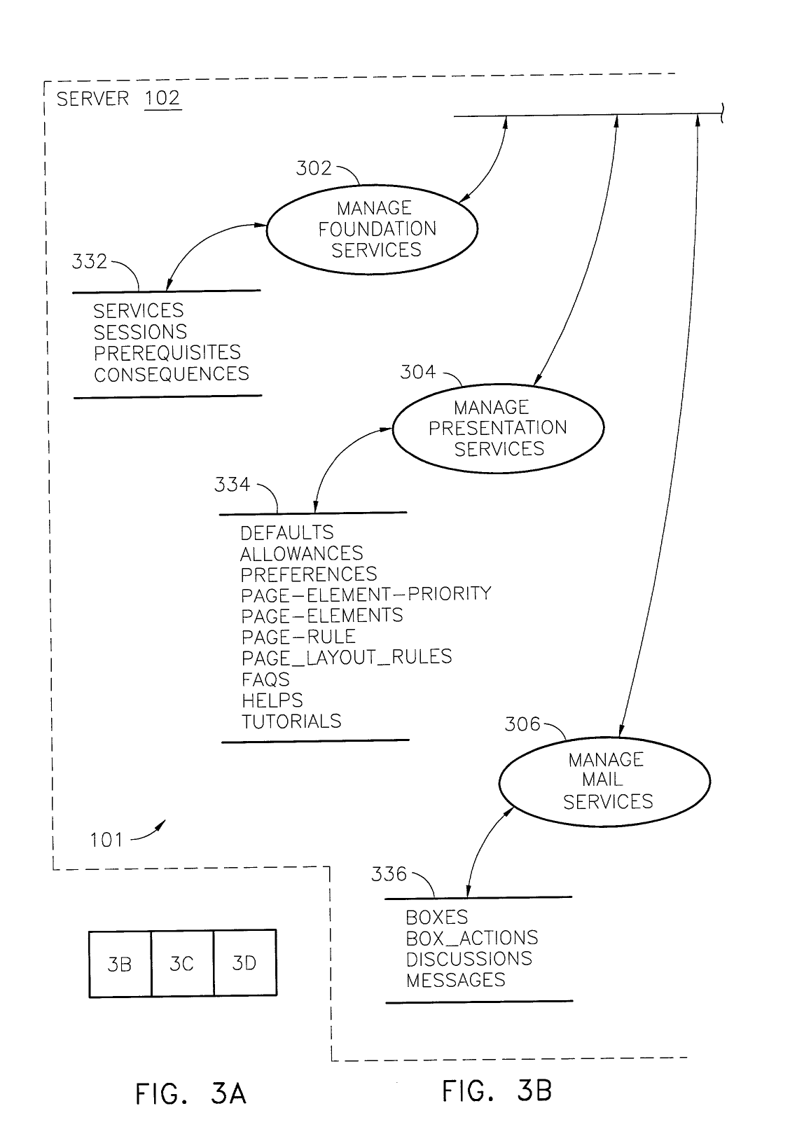

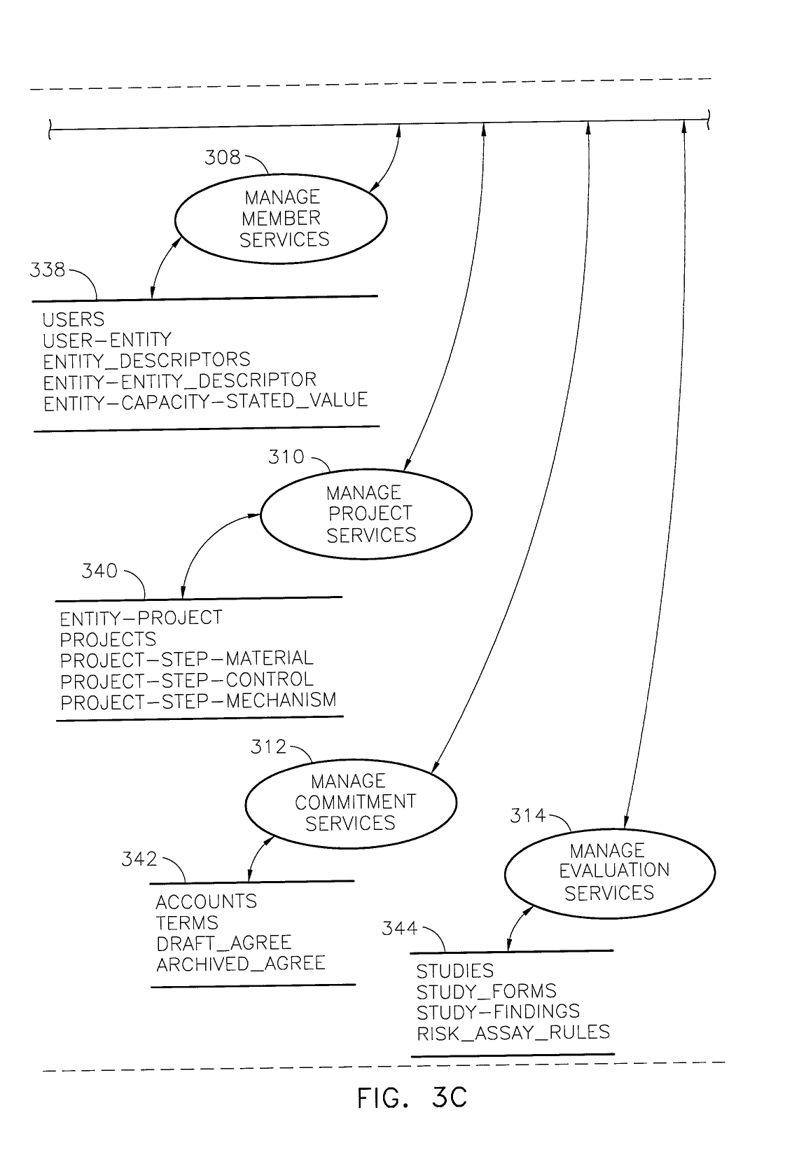

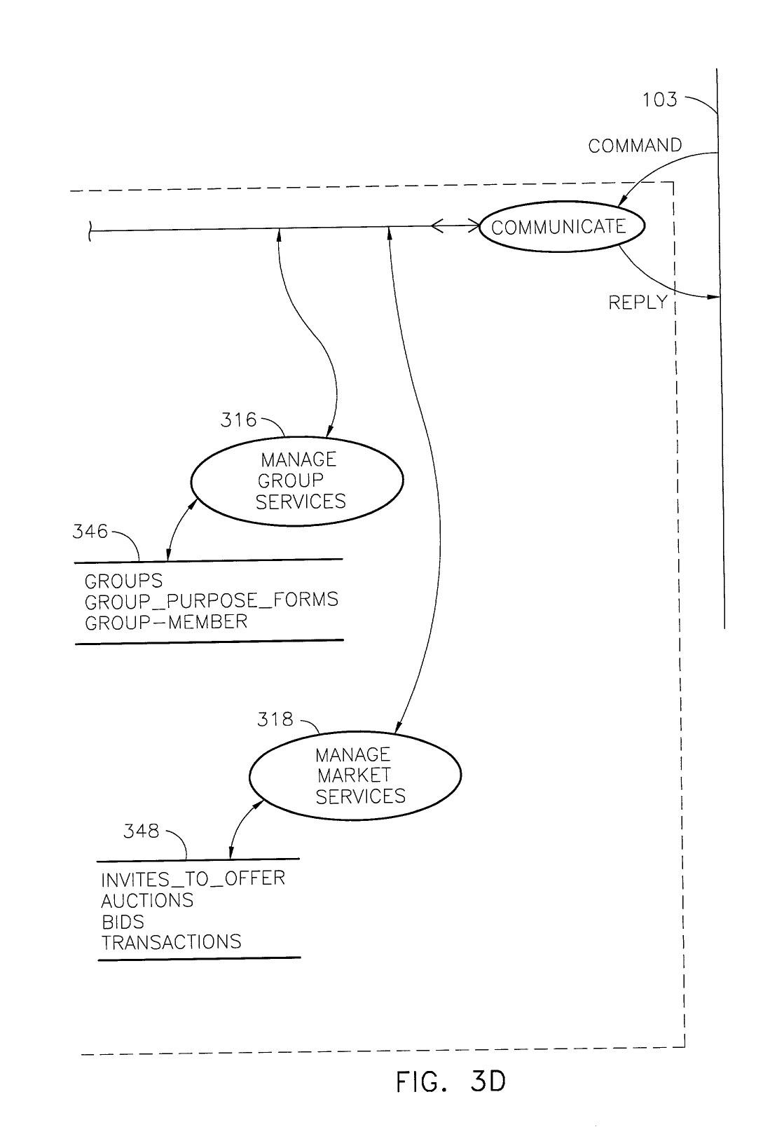

Server 102 (representative of any server of system 100) may be implemented according to the functional block diagram of FIGS. 3A, 3B, 3C, and 3D. The implementation shown is suitable for performing the methods described below. Other implementations may result from a different assignment of functions to modules and assignment of data items to records and files. The function and data organizations discussed below may be reorganized to accomplish any system goal including, for example, priority access to most frequently accessed items and priority control of services (e.g., ownership of particular objects in an object oriented process design) that are likely to be expected to be completed within particular maximum times. In the implementation shown, server 102 includes BCTMS 101 software that includes: Manage-foundation-services process 302, Manage-presentation-services process 304, Manage-mail-services process 306, Manage-member-services process 308, Manage-project-services process 310, Manage-commitment-services process 312, Manage-evaluation-services process 314, Manage-group-services process 316, Manage-market-services process 318, Communicate process 110, and node data 116 (not shown). All management processes receive direction and provide results via Communicate process 110. In addition, management processes 302-318 may cooperate via any conventional mechanism for interprocess communication (e.g., linked function call, RPC, advertisement and brokering, shared memory, monitored database activity, satisfaction of prerequisites, etc.).

For a better understanding of the cooperation of management processes 302-318, node data 116 is described in FIGS. 3A, 3B, 3C, and 3D as comprising groups of data files (and supporting indexes, not shown). Each file group is primarily (and, importantly, not exclusively) used by one of the management processes discussed above. File group 332 includes SERVERS file, SESSIONS file, PREREQUISITES file, and CONSEQUENCES file for use by Manage-foundation-services process 302. File group 334 includes DEFAULTS file, ALLOWANCES file, PREFERENCES file, PAGE-ELEMENT-PRIORITY file, PAGE_ELEMENTS file, PAGE-RULE file, PAGE_LAYOUT_RULES file, FAQS file, HELPS file, and TUTORIALS file for use by Manage-presentation-services process 304. File group 336 includes BOXES file, BOX_ACTIONS file, DISCUSSIONS file, and MESSAGES file for use by Manage-mail-services process 306. File group 338 includes USERS file, USER-ENTITY file, ENTITY_DESCRIPTORS file, ENTITY-ENTITY_DESCRIPTOR file, and ENTITY-CAPACITY-STATED_VALUE file for use by Manage-member-services process 308. File group 340 includes ENTITY-PROJECT file, PROJECTS file, PROJECT-STEP-MATERIAL file, PROJECT-STEP-CONTROL file, and PROJECT-STEP-MECHANISM file for use by Manage-project-services process 310. File group 342 includes ACCOUNTS file, TERMS file, DRAFT_AGREE file, and ARCHIVED_AGREE file for use by Manage-commitment-services process 312. File group 344 includes APPROVALS file, FINDINGS file, STUDIES file, and RISK_ASSAY_RULES file for use by Manage-evaluation-services process 314. File group 346 includes GROUPS file, GROUP_PURPOSE_FORMS file, and GROUP-MEMBER file for use by Manage-group-services process 316. File group 348 includes INVITES_TO_OFFER file, AUCTIONS file, BIDS file, and TRANSACTIONS file for use by Manage-market-services process 318.

Each file described above may be implemented as a portion of any conventional physical database architecture. For convenience of this description each file is considered to include a table of columns and rows wherein each record corresponds to a row and includes a named field for each column. Generally, the information value of a field in a record has a uniform type across all records of the file. Each record may be understood to correspond to a data structure as that term is used in conventional programming languages such as C and C++. Access to information in the table may be by one or more indexes for implementation of any conventional database functions (e.g., queries, intersections, or joins).

In the record descriptions that follow, any suitable data types may be used (and may be assumed by managing processes 302-318) including integer, a predetermined data structure, a fixed-length character string, a reference to a variable length character string, or a reference to a variable length value such as a bitmap, recorded voice, or video. Any conventional technology for providing suitable access to files having variable record lengths may be used for stated values that include an unstated extent.

Alternatively, any data item may have a value that includes embedded data type information. In one implementation, the value may be a data structure that includes predetermined coded values conveying data type information preceding an actual value. In a preferred implementation, the value may be expressed in a markup language that describes the data type in a metatag that precedes (or a pair of metatags that surround) the value. For example a StatedValue (discussed below) may be expressed as text: “<volt>9.6</volt>”. A search for data of a particular significance may be implemented as a search for metatags, values or combinations (including conventional logical proximity criteria and partial expansion using wild cards). Such a search may be included, for example, in a validation prerequisite.

Any data item may be arbitrarily complex as may be desired to provide flexibility for otherwise unanticipated business capacity transaction information. Data items described in singular may be a list or list of lists to any suitable complexity. For example, StatedValue, Prerequisite, GroupPurposeForm, Term, and others (discussed below) may be expressed in a manner that includes organizational metatags delineating a reference to a list, or a list whose member items include any combination of data item value, references, or lists to effect nested lists of any complexity. Preferably, a stated value must be of the same organization as the data item to which it is associated.

In an alternate implementation, each record having a field for a data item of non-predetermined type may be preceded by a field that admits any suitable data item that describes the data type information to be used for the next field (e.g., a prototype declaration in ANSI C, or the format declaration in an “sprint” call in ANSI C).

As used herein, a stated value (e.g., PrerequisiteStatedValue, DefaultStatedValue, etc.) is a value that causes the record as a whole to be subject to validation. Generally, user input is recorded in suitable stated values. A record containing a stated value, a validation prerequisite, and a nomination prerequisite is (a) accessible for entry/edit of the stated value while the validation and nomination prerequisites are not met; (b) accessible for evaluation by investigating and auditing users while the validation prerequisite is met and while the nomination prerequisite is not met; and (c) is accessible for all suitable purposes while both prerequisites are met.

TABLE 1

| File Name and Field Names of each record | Description |
|---|---|
| SERVERS | Network 103 may include any number of servers |
| ServerId | for tandem processing, mirrors, redundant on-site |
| NetworkAddress | processing, replacement processors, or off-line |
| ServerPhysicalLocation | reserve processors. Activation of a server may be |
| ServerOperationPrerequisite | automatic on satisfaction of |
| | ServerOperationPrerequisite. |
| | A server's physical location supporting a |
| | particular session may indicate to which |
| | jurisdiction's laws a session must comply. Any |
| | prerequisite (see PREREQUISITES file, infra.) |
| | may include dependence on |
| | ServerPhysicalLocation to assure compliance with |
| | law. |
| SESSIONS | Each session may be presumed to involve one |
| SessionId | user, whether unregistered or registered. |
| ServerId | Any prerequisite (see PREREQUISITES file, |
| StartDateTime | infra.) may include dependence on the duration of |
| GroupId (e.g., of a conference) | a session. For example, if interruption of a |
| | session is detected by noting a UserId (see |
| | USERS file, infra.) requesting a new session |
| | when a current session of the same UserId is in |
| | operation or less than a predetermined time has |
| | lapsed between sessions, the user's prior session |
| | context may be offered to be restored. Chat |
| | rooms for users may be implemented as an ad hoc |
| | GroupId (see GROUPS file infra.). A prerequisite |
| | to continuing the conference (i.e., a termination |
| | initiated by BCTMS 101) may include a |
| | dependency on activity from each member of the |
| | group during a period of time. |
| PREREQUISITES | A prerequisite may include a logical conditional |
| PrerequisiteId | expression calling for the evaluation of any |
| PrerequisiteLabel | information accessible to BCTMS 101 and the |
| PrerequisiteStatedValue | operating system of any server. The action to be |
| ValidationPrerequisite | taken when a prerequisite is satisfied may be |
| NominationPrerequisite | implied by the field name, by the position of the |
| | prerequisite in a record's data structure, or be |
| | specified as one or more predicates to the |
| | prerequisite. A predicate may identify one or |
| | more ConsequenceIds to indicate the associated |
| | Consequence Algorithms to be performed when |
| | the prerequisite is satisfied. |
| CONSEQUENCES | A consequence includes any actions taken by |
| UsePrerequisite | BCTMS 101 initiated upon occurrence of an |
| ConsequenceId | event. For example, BCTMS may include agents |
| ConsequenceAlgorithm | or daemons, inter alia, to monitor satisfaction of a |
| ValidationPrerequisite | prerequisite and initiate performance of a |
| NominationPrerequisite | predicate consequence. An event may be the |
| | determination of any system information item to |
| | any suitable value. An event may be the |
| | recognition by the system that a stated value (or a |
| | record having several stated values) has been |
| | validated, as discussed above. Actions that may |
| | be taken include notifying a group, closing an |
| | auction, establishing that an event has occurred, |
| | establishing the subject or predicate of another |
| | prerequisite, evaluating another prerequisite, etc. |
| | For example, when a ValidationPrerequisite is |
| | satisfied, BCTMS 101 may write into the |
| | validated record a suitable predetermined |
| | NominationPrerequisite by operation of a |
| | ConsequenceAlgorithm indicated in the predicate |
| | of the ValidationPrerequisite. |

Manage-foundation-services process 302, using file group 332 of TABLE 1, assures that the following services are performed at suitable time intervals: (a) recognizing a change in the availability of a server so as to revise records in SERVER and SESSION files and perform any load sharing or soft fail functions related to particular sessions; (b) recognizing a command from a user to begin a sign-on sequence so that a session may be associated with the user; (c) facilitating conventional chat room message transfers by indicating that particular sessions are members of a group (e.g., an ad hoc group) associated with a particular chat room; (d) terminating sessions; and (e) event monitoring for satisfaction of prerequisites and scheduling or performing algorithms (e.g., scripts or programs) to effect prescribed predicates and consequences.

Prerequisites may be used to assure that system operation intelligently supports the user's use of the system without compromise to other system functions, including for example, security or the reliability of information items on the site. UsePrerequisites may include dependencies on user, session, or group identification to provide limited access to particular records (e.g., to FAQS, BELPS, and TUTORIALS) so as not to compromise nondisclosure agreements or confuse the user who does not have authorization to act on the information presented). For example, a UsePrerequisite may depend on existence of a particular agreement (e.g., a nondisclosure agreement) or existence of a type of agreement (e.g., a consortium membership agreement that includes nondisclosure terms). UsePrerequisites may depend on successful queries of any node data 116. UsePrerequisites may include any conventional data access control, including for example, permission to read, write, modify, create, copy, duplicate, execute, link to, delete, append, or locate data or code. These permissions may be aggregated in any convenient manner and associated (for purposes of suitable data or code) with suitable names, for example, owner, author, reviewer, editor, publisher, administrator, investigator, auditor, etc.

Prerequisites may include suitable dependencies on any information item of BCTMS 101 or any other server of network 103. For example, when network 103 includes the World Wide Web, stock price information reported by another site (e.g., in XML) may be obtained and referred to in a suitable prerequisite. Further, any system variable or status, stated value, group membership, page presented in the current session, existence of approvals, satisfaction of another prerequisite, auction status, or bid status, to name a few possibilities.

The records of node data 116 refer frequently to UsePrerequisites (to selectively provide access privileges as discussed above), ValidationPrerequisites, and NominationPrerequisites. A ValidationPrerequisite is a test for the validity of a record prior to permitting the record to be posted or modified. Such a prerequisite may refer to any number of other records in any files of BCTMS 101, as discussed above. A NominationPrerequisite is a test that if successful implements a significant change to operation of BCTMS 101. A nomination may put in place a structural change that affects many users, for example, the adoption of a group purpose form used to create a new type of group to be recognized on the site.

Structural changes (e.g., changes to node data) may be accomplished in an orderly manner by monitoring submissions and prerequisites. For example, one scenario (e.g., including several sessions) proceeds through the following steps as for a membership group purpose form: (a) a user proposes a new membership group purpose form; (b) BCTMS 101 (e.g., by monitoring submissions) validates the proposed membership group purpose form in accordance with a validation prerequisite suitable for application to all new membership group purpose forms (e.g., defined by a system manager); (c) upon successful validation BCTMS 101 notifies relevant investigators and/or auditors that the new membership group purpose form is available for review; (d) investigators and/or auditors complete requisite studies to provide findings directed to the structure of the membership group purpose form itself (e.g., is it appropriate to require all members to be fluent in a particular human language?); (e) BCTMS 101 (e.g., by monitoring prerequisites) recognizes that findings or an auditor's approval satisfy a nomination prerequisite and indicates that the group purpose form has been successfully nominated; (f) BCTMS 101 permits access to and use of the group purpose form in the same manner as all nominated forms and may create prerequisites (e.g., UsePrerequisites for data associated with a group whose membership depends upon the new nominated group purpose form); (g) various users apply for group membership by filling out particular instances of the nominated group purpose form; (h) BCTMS 101 (e.g., by monitoring submissions) validates the particular instances of the group purpose form according to criteria provided with or associated with the group purpose form; (i) upon successful validation BCTMS 101 notifies relevant investigators and/or auditors that the particular group purpose forms are available for review; (j) investigators or auditors (perhaps different from those in step (d)) complete requisite studies to provide findings; (k) BCTMS 101 recognizes that findings or an auditor's approval satisfy a nomination prerequisite for one or more of the particular group purpose forms and indicates that these group purpose forms have been successfully nominated; (1) BCTMS 101 (e.g., by monitoring prerequisites) implements all prerequisites depending on the group purpose form, for example, when access to particular node data is requested, BCTMS 101 permits such access to the various users according to use prerequisites that depend upon successful nomination under the group purpose form.

A NominationPrerequisite may itself be proposed, validated, and be subject to nomination. For example, members of a selling group may be permitted to announce the sale of products only when such products are successfully nominated as members of a capacity group.

A record having one or more prerequisite fields may have in addition a respective field for a binary result of each prerequisite so that evaluation of prerequisites may focus on unmet prerequisites and the status of a prerequisite may be ascertained in some situations without evaluating the prerequisite.

Evaluation of a prerequisite may include resolving parametric references for example to search results of node data 116, client data 144, or results of commands issued on network 103 to other servers as discussed above. These references may be assigned values according to a scope or hierarchical context beginning with the user's present utilization of BCTMS 101 and proceeding backward in utilization (or another suitable hierarchy) for further resolution of intentionally permitted ambiguities.

TABLE 2

| File Name and Field Names of each record | Description |
|---|---|
| DEFAULTS | Defaults permit, inter alia, a system administrator |
| DefaultLabel | to define an initial configuration upon which |
| DefaultStatedValue | diagnostics or tutorials may rely. |
| ValidationPrerequisite | |
| ALLOWANCES | A preference (see PREFERENCES file, infra.) or |
| UserId | a default (see DEFAULTS file supra.) may |
| AllowanceLabel | provide a value that must lie within the allowance |
| AllowanceStatedValue | value (e.g., a range) for an associated named |
| ValidationPrerequisite | allowance. Allowances may also be implemented |
| | for any information item in the system, for |
| | example, any stated value in a group purpose |
| | form. |
| PREFERENCES | Preferences may describe the current value of |
| UserId | user-specific variables that may affect any aspect |
| PreferenceLabel | of operation or appearance of information from |
| PreferenceStatedValue | BCTMS 101. A PreferenceStatedValue may |
| ValidationPrerequisite | initially be automatically assigned from a |
| | DefaultStatedValue. If a PreferenceStatedValue is |
| | modified, it must remain within constraints |
| | specified by any suitable associated (e.g., by |
| | related labels) AllowanceStatedValue. |
| PAGE-ELEMENT-PRIORITY | Each record includes a tuple of page, element, and |
| UsePrerequisite | priority identifications. Platform independent |
| PageId | presentation of pages may be accomplished by |
| PageElementId | selecting the elements designated for a particular |
| Priority | page, arranging them in priority for placement, |
| ValidationPrerequisite | and satisfying all layout rules associated with the |
| | page. Some elements may be standard to all |
| | pages. For example, references to Help, FAQ, and |
| | Tutorials (i.e., links to PageIds that include |
| | HelpId, FaqId, and TutorialId) may be context |
| | sensitive elements automatically provided in all |
| | pages. These elements may be presented if the |
| | associated UsePrerequisite allows at least one type |
| | of use (e.g., read access). |
| PAGE_ELEMENTS | Each page displayed to a user during a session |
| UsePrerequisite | may be a composition of elements. Elements may |
| PageElementId | be fixed in value (e.g., text, background, graphics, |
| PageElementType: (Enumeration of:) | links) or may have content that is determined by |
| Text | an algorithm just before the element is presented |
| Graphic | on a page. The algorithm may include any set of |
| Animation | system operations including database queries of |
| Control | any complexity. |
| ProcessingResult | |
| InSiteLink (e.g., a PageId) | The NominationPrerequisite may assure, for |
| OutSiteLink (e.g., a web address or search | example, by appropriate auditor's review that |
| criteria) | suggested page elements (a) do not use data |
| FAQ | acquired from other authors without suitable |
| Help | disclaimers and credits; and (b) include |
| Tutorial | appropriate information or references (e.g., |
| Algorithm | UsePrerequisites or links) to other node data. |
| PageElementStatedValue | |
| ValidationPrerequisite | |
| NominationPrerequisite | |
| PAGE-RULE | Each record is a tuple of page and rule |
| UsePrerequisite | identifications. Page layout rules may determine |
| PageId | how and whether an element is presented. |
| RuleId | Different rules may apply to each page, for |
| NominationPrerequisite | example, for controlling access or sequence (e.g., |
| | next page in a tutorial). |
| PAGE_LAYOUT_RULES | Page layout rules may affect the position of an |
| UsePrerequisite | element on a page (e.g., links may be hidden if the |
| PageLayoutRuleId | user is not permitted to traverse them), the size or |
| PageLayoutRuleAlgorithm | layout of data tables, font, color, language, |
| ValidationPrerequisite | orientation, display layer, or protocol (e.g., XML, |
| | HTML, or other). |
| FAQS | Frequently Asked Questions (FAQs) are provided |
| UsePrerequisite | in the context of the user's role which may be |
| FaqId | implemented as a general role (e.g., supplier) and |
| FaqLabel (e.g., topic) | a particular role which describes the context of the |
| FaqQuestion | current session (e.g., a prediction of what the user |
| FaqAnswer | may be seeking to accomplish based on user's |
| ValidationPrerequisite | group memberships, current page being presented, |
| NominationPrerequisite | etc.). FAQ answers may have links to help texts |
| | or other FAQ answers. |
| HELPS | Help text describes page elements that may raise |
| UsePrerequisite | questions when viewed. Such questions may |
| HelpId | include, for example, what an abbreviation |
| HelpLabel (e.g., topic) | represents, the definition of terminology, or the |
| HelpText | basis for a numeric representation. Help text may |
| ValidationPrerequisite | include links to other help texts or to FAQ |
| NominationPrerequisite | answers. |
| TUTORIALS | Tutorials provide user education which may be of |
| UsePrerequisite | general utility (e.g., how to place a bid) or may be |
| TutorialId | particular to an Entity (information provided by |
| TutorialLabel (e.g., topic) | an Entity about its products and processes, |
| TutorialText | possibly requiring a nondisclosure agreement as a |
| ValidationPrerequisite | prerequisite to access). Tutorials may use links to |
| NominationPrerequisite | provide sequence or be organized as a network or |
| | graph. Links may be activated to one of several |
| | destinations dependent upon user input (e.g., an |
| | answer to a quiz question for self-paced |
| | instruction). |

Manage-presentation-services process 304, using file group 334 of TABLE 2, assures that the following services are performed at suitable time intervals: (a) facilitating the creation, modification, or deletion of one or more defaults, allowances, and preferences by any suitably authorized user; (b) facilitating the performance of service (a) above in response to group membership so as to make uniform an aspect of the presentation of information related to a business capacity transaction; (c) providing a presentation to a user of information related to a business capacity transaction in accordance with present values of preferences that are limited by allowances and/or set to defaults; (d) limiting access to information (e.g., any access privilege) related to a business capacity transaction based on a use prerequisite and information associated with the user (e.g., information from SESSIONS, USERS, GROUPS, TERMS, and ACCOUNTS files), inter alia, to assure that BCTMS 101 does not contribute to the breach of terms of any agreement (e.g., provide information in advance of payment when prior payment is expected).

TABLE 3

| File Name and Field Names of each record | Description |
|---|---|
| BOXES | Users, Entities, and Groups may communicate |
| UsePrerequisite | using email that is deposited and maintained in |
| BoxId | email boxes. Many boxes may refer to the same |
| MessageId | message (e.g., a broadcast). By operation of |
| | suitable UsePrerequisites that identifies one or |
| | more UserIds, EntityIds, and/or GroupIds, a user |
| | may have access (e.g., as owner) to any number of |
| | boxes. |
| BOX_ACTIONS | Message boxes may be used to coordinate action |
| UsePrerequisite | expected by the sender. Whether specification of |
| BoxId | an ActionDueStatedValue was inadvertently |
| MessageId | omitted may be checked by a |
| ActionRequiredStatedValue | ValidationPrerequisite. Whether action was taken |
| ActionDueDateTimeStatedValue | may be the subject of a Prerequisite related to an |
| ActionTakenOnDateTimeStatedValue | Approval or a Study. |
| ActionTakenByUserIdStatedValue | |
| ValidationPrerequisite | |
| NominationPrerequisite | |
| DISCUSSIONS | Threaded discussions facilitate updates to data |
| UsePrerequisite | items of BCTMS 101 based on common |
| DiscussionId | understanding and awareness. Messages may be |
| DiscussionLabel (e.g., topic | listed in chronological order. Discussions may be |
| ParentDiscussionId | ordered hierarchically. |
| MessageId | |
| MESSAGES | Messages may be addressed to another user, to a |
| UsePrerequisite | group (e.g., a chat), or to a discussion topic. |
| MessageId | Nomination may assure review by an entities |
| MessageDateTimeReceived | proper authorities before the message is sent. |
| MessageAuthor (e.g., UserId) | MessageAddresseeStatedValue may specify one |
| MessageAddresseeStatedValue | or several of the following in any combination: |
| MessageStatedValue | BoxId, DiscussionId, UserId, EntityId, or |
| ValidationPrerequisite | GroupId. By specifying a GroupId, the message |
| NominationPrerequisite | may be associated (by operation of a suitable |
| | nominated algorithm) to one or several BoxId, |
| | DiscussionId, UserId, and/or EntityId. Email |
| | delivery may thereby be anonymous and delivered |
| | according to content. |

Manage-mail-services process 306, using file group 336 of TABLE 3, assures that the following services are performed at suitable time intervals: (a) depositing mail addressed to the user into a box associated with the user; (b) issuing notices to a user and to a sender on the occurrence of the user's failure to take action as expected by the sender within the prescribed time period; (c) facilitating posting, search, threaded review, and reference in later messages to the messages constituting a discussion; (d) prohibiting the sending of messages from an entity when the message has not received expected review and approval by others; (e) transferring box contents to client data 144 to accomplish delivery of mail for off-line use by the user.

Manage mail services process 306 may cooperate with manage presentation services 304 to present messages (e.g., from boxes, discussions, or chat rooms) and may cooperate with Manage-foundation-services process 302, for example, when a consequence involves analysis or presentation of a message or when the receipt or nonreceipt of a particular message satisfies a prerequisite. Sending a message may be implemented as a consequence of nomination of an instance of a group purpose form that includes: (a) the message as a stated value subject to validation and nomination; (b) one or more addressees as stated values subject to validation and nomination; and (c) references to other node data subject to validation and nomination so as to satisfy one or more prerequisites to bring about consequential actions. When a member of one entity proposes a message to another entity, such a group purpose form may assure, inter alia, that necessary formalities (e.g., legal, political, and cultural) are met and that if the message satisfies a contractual obligation, that BCTMS 101 is enabled to take appropriate automatic actions (e.g., establish or evaluate consequences of other prerequisites).

TABLE 4

| File Name and Field Names of each record | Description |
|---|---|
| USERS | Unregistered users may have limited use of |
| UserId | BCTMS 101. A UserId may be an IP address or |
| SessionId | may be a proxy for such an address (e.g., a |
| PlatformStatedValue | UserName). If platform independence cannot be |
| PageId | otherwise assured, the site may acquire |
| | information so as to identify the platform used in |
| | this session. An initial (home) page may be |
| | designated and later revised according to the |
| | user's registration, if any. Users may operate any |
| | number of sessions simultaneously. |
| USER-ENTITY | Each record is a tuple of user and entity |
| UsePrerequisite | identifications. This file may be revised |
| UserId | automatically upon successful approval of a |
| UserName | MembershipPrerequisite (see GROUPS file, |
| EntityId | infra.) for a user or an entity. This file illustrates |
| EntityName | a technique for providing indexed access to user |
| ValidationPrerequisite | name and entity name that may be otherwise |
| NominationPrerequisite | buried in a StatedValue item. Files of this |
| | structure may be created and added to node data |
| | 116 to provide any suitable access to any desirable |
| | association of stated values. Note that a user may |
| | be associated with any number of entities and vice |
| | versa. |
| ENTITY_DESCRIPTORS | An entity may describe itself using any number of |
| UsePrerequisite | descriptors. Preferably a common set of |
| EntityDescriptorId | descriptors would be used at least in each business |
| EntityDescriptorLabel | sector. A DescriptorLabel may be a short phrase |
| EntityDescriptorStatedValue | such as “Name” or “Fax Number”. Labels (as |
| ValidationPrerequisite | used in various node data 116) may be metatags |
| NominationPrerequisite | as discussed above. Help texts may be |
| | implemented to assure valid entries for labels and |
| | stated values. An entity may specify by descriptor |
| | an alias for anonymous use of BCTMS 101. |
| ENTITY-ENTITY_DESCRIPTOR | Each record includes a tuple of entity and entity |
| UsePrerequisite | description identifications. An entity may be a |
| EntityId | person, partnership, or corporation to which a user |
| EntityDescriptorId | is associated with (e.g., an officer of, employee of, |
| ValidationPrerequisite | consultant to, or agent for the entity). An entity |
| NominationPrerequisite | may have several data items associated with it. |
| | This one-to-many relationship is supported here |
| | with as many data items of different kinds as |
| | needed to record desirable information, such as, |
| | EntityWebSites, EntityPhysicalAddresses, and |
| | EntityVoicePhone, etc. |
| ENTITY-CAPACITY-STATED_VALUE | Each record includes a tuple of entity, capacity, |
| UsePrerequisite | and stated value identifications. This file may be |
| EntityId | revised automatically upon successful approval of |
| CapacityName | MembershipPrerequisites (see GROUP file, |
| CapacityStatedValue | infra.) for a business capacity (see GROUP- |
| | MEMBER file, infra.). Therefore, validity and |
| | nomination prerequisites may be omitted. |

Manage-member-services process 308, using file group 338 of TABLE 4, assures that the following services are performed at suitable time intervals: (a) supporting Manage-foundation-services process 302 in recognizing a newly signed-on registered user; (b) facilitating registration of an unregistered user; (c) associating the user with an entity (e.g., a company the user is employed by or acts as agent for); (d) associating information about an entity to the entity name; (e) associating business capacities to the entity in accordance with validation and nomination prerequisites; and (f) limiting access to information about users and entities in accordance with use prerequisites.

Manage-member-services process 308 cooperates with Manage-group-services process 316 to append, revise, and delete records in ENTITY-CAPACITY-STATED_VALUE file.

Nomination prerequisites permit an orderly association of an entity and a business capacity. The entity may be suitably identified and qualified as a supplier or consumer of particular business capacities. For example, a group of qualified entities may be formed for which membership by an entity requires nomination using a first group purpose form describing the entity. Suitable investigators and/or auditors may corroborate the information supplied on the first group purpose form. In addition, a group may be formed for which membership by a business capacity as supplied by or demanded by a qualified entity requires nomination using a second group purpose form describing both the capacity and the entity (e.g., reference to the entity's membership status in a particular group may be sufficient). Again, auditors may corroborate the information supplied on the second group purpose form. In each case a group of investigators and/or auditors may be formed for which membership by a particular user requires nomination using a third group purpose form typically investigated and/or audited by a system manager, staff operating system 100, or their delegee.

TABLE 5

| File Name and Field Names of each record | Description |
|---|---|
| ENTITY-PROJECT | Each record includes a tuple of entity and project |
| UsePrerequisite | identifications. An entity may track progress of |
| EntityId | complex product development/provisioning |
| ProjectId | arrangements, each arrangement may be one |
| | project. Or, multiple arrangements may be |
| | integrated into one or a few projects. |
| PROJECTS | A project may be a member of a group (e.g., for |
| UsePrerequisite | management of similar production in different |
| ProjectId | scenarios, territories, by different groups of |
| ProjectLabel | Entities, etc.). If so, ProjectId may be expressed |
| StepId (last step) | as GroupId and MemberId. |
| ValidityPrerequisite | |
| STEPS | Each project is modeled as a network of steps; |
| ProjectId | each step having an input (raw materials or |
| StepId | materials from another step), controls (procedures |
| ParentStepId | and evaluations), mechanisms (capacities), and |
| | output (resulting materials or materials for another |
| | step). |
| PROJECT-STEP-MATERIAL | Each record includes a tuple of project, step, and |
| UsePrerequisite | material identifications. A material includes any |
| ProjectId | non-labor thing that is consumed (changed in |
| StepId (this step) | some way) or comes into being by performing the |
| StepId (step that provides the material) | step. A step may be associated with any number |
| MaterialUtilization | of input materials and output materials. If the |
| MaterialId | providing StepId is null, the material is a raw |
| ValidityPrerequisite | material to the project. An input or an output |
| NominationPrerequisite | material as used herein may include any tangible |
| | thing (e.g., a substance, subassembly, worksheet, |
| | finished product). A material may be a member |
| | of a group. If so, MaterialId may be expressed as |
| | GroupId and MemberId. MaterialUtilization may |
| | be an enumeration (e.g., a binary indicator) that |
| | the MaterialId is used as an input to the step or as |
| | an output from the step. In an alternate |
| | implementation, other MaterialUtilization values |
| | may be used to describe the extent to which the |
| | material is consumed by the step (e.g., for cost |
| | management) or extent that it is required (e.g., |
| | intermittent labor for spot checks). MaterialId |
| | may include any input including an output of any |
| | step (a material, a service, a status or a |
| | configuration). |
| PROJECT-STEP-CONTROL | Each record includes a tuple of project, step, and |
| UsePrerequisite | control identifications. A control includes any |
| ProjectId | labor or non-material aspect of a thing involved in |
| StepId | the performance of the step including a service |
| ControlId | (e.g., trained labor, informed advisor, etc.) or a |
| ValidityPrerequisite | status or configuration (e.g., equipment set up and |
| NominationPrerequisite | ready, data available for access, funds available, |
| | group formed, notice given, etc.). A control may |
| | be a member of a group. If so, ControlId may be |
| | expressed as GroupId and MemberId. |
| PROJECT-STEP-MECHANISM | Each record includes a tuple of project, step, and |
| UsePrerequisite | mechanism identifications. A mechanism |
| ProjectId | includes any resource used in performing the step |
| StepId | whose cost is amortized rather than accounted for |
| MechanismId | directly (e.g., tools, capital equipment, use of an |
| ValidityPrerequisite | information system, assembly instructions, a test |
| NominationPrerequisite | procedure). For example, a facility may be a |
| | mechanism when the full purchase price of the |
| | facility is not to be accounted for against this step. |
| | A mechanism may be a member of a group. If |
| | so, MechanismId may be expressed as GroupId |
| | and MemberId. |

Manage-project-services process 310, using file group 340 of TABLE 5, assures that the following services are performed at suitable time intervals: (a) assisting the determination of the form, name, and purpose of a new project; (b) assisting the definition and editing of steps that form a project; (c) providing context sensitive help text during the project definition or editing, such help text directing the user to conform to nominated sequences of steps and step definitions; and (d) facilitating the nomination of sequences, steps, materials, controls, and mechanisms.

Projects that include nominated steps, sequences, materials, controls, or mechanisms may have greater economic value and lower risk of failure than other projects . Nomination generally refers to the satisfaction of one or more NominationPrerequisites. Because any prerequisite may include a dependence on approval by a particular user or any suitable number of members of a group of users (e.g., member entities of an industry consortium), nomination may assure that information used in business capacity transactions has a measure of reliability which may conform to a commercially reasonable standard. Steps, sequences, materials, controls, or mechanisms may be nominated (e.g., by industry analysts or automatically according to supply and demand information known to BCTMS 101) and suggested or incorporated for use in various projects (e.g., projects entered or managed by a user, or projects initiated or managed by BCTMS 101). For example, in response to high availability of a particular material, a project having a step that may use one of several input materials may be instantiated to use the material in current high availability; in response to high demand for a particular material, a project having a step that may produce one of several output materials may be instantiated to produce the material in shortest supply. The same may be said for controls and mechanisms. In alternate implementations, reliance on availability may be replaced with reliance on profit margin or any suitable measure of risk or reward.

TABLE 6

| File Name and Field Names of each record | Description |
|---|---|
| ACCOUNTS | An account is maintained for each entity for |
| UsePrerequisite | charging for actions taken by users that are |
| EntityId | associated to that entity. Money deposited or |
| AccountId | withdrawn from the account is described here. |
| PostingDateStatedValue | Withdrawals may be for payment for services |
| AmountStatedValue | rendered by this site, payments to sellers or |
| PurposeStatedValue | vendors. Deposits may be for any purpose related |
| NarrativeStatedValue | to functions of the site (e.g., transaction escrow, |
| ValidityPrerequisite | or minimum royalty payment prescribed by an |
| NominationPrerequisite | Agreement). An entity may have any number of |
| | accounts, preferably using standardized |
| | PurposeStatedValues for aggregation, |
| | summarization, and report generation. |
| TERMS | Agreements (including licenses) between entities |
| UsePrerequisite | are created from terms that may be tailored using |
| TermId | particular values for parameters appearing in the |
| TermForm (in blank) | text of the term. For example, a term that defines |
| TermFormParameterNames | required notice may have parameters for the |
| TermFormParameterDescriptions | address to be used for notice. Terms may be |
| ValidationPrerequisite | provided in the form of a DTD or rely on a DTD |
| NominationPrerequisite | for filling in parametric values. |
| DRAFT_AGREE | The process of negotiating an agreement may be |
| UsePrerequisite | facilitated by approving terms one at a time rather |
| AgreementId | than attempting to reach agreement on an entire |
| TermId | draft at one time. Validity prerequisites may be |
| TermSequenceNumber | used to accomplish signatures for an entire |
| TermStatedValue | agreement (e.g., the final term in the sequence |
| ValidityPrerequisite | may be merely a signature block). |
| NominationPrerequisite | |
| ARCHIVED_AGREE | An agreement is “written” as the user(s) select |
| UsePrerequisite | terms and tailor the terms by inserting parameter |
| AgreementId | values. The terms as they exist at the time of |
| FullAgreementText | execution of the agreement are archived. Future |
| | agreements may use revised or different terms. |

Manage-commitment-services process 312, using file group 342 of TABLE 6, assures that the following services are performed at suitable time intervals: (a) demanding and receiving payment of monetary amounts in accordance with terms of agreements maintained by BCTMS 101; (b) providing status of accounts including whether or not posted amounts have been nominated (e.g., approved by an auditor to particular criteria specified in a NominationPrerequisite (possibly referring to a subordinate study and particular findings)); (c) managing the formation of agreements by directing the user to conform to nominated groups of agreements, sequences of terms in an agreement, and term definitions; (d) notifying relevant users (or groups of users) when review, acceptance, or action in response to a term of an agreement may be desirable or necessary; (e) facilitating the nomination of groups of agreements, sequences of terms, and term definitions; and (f) facilitating anonymous use of BCTMS 101 for making inquiries and gathering information about business capacities, for executing nondisclosure agreements wherein the anonymous user's identity is made known to selected parties, and for facilitating further information exchange for a business capacity transaction.

Manage-commitment-services process 312 cooperates with Manage-foundation-services process to provide information and status relevant to determination of prerequisites. For example, when a nondisclosure agreement is expected to be executed before particular UsePrerequisite is satisfied to permit read access to certain records, Manage-foundation-services process obtains status of the related agreement from Manage-commitment-services process. An agreement may become the subject of a UsePrerequisite, for example, automatically by operation of a consequence brought into effect in response to a predicate of an agreement's NominationPrerequisite.

TABLE 7

| File Name and Field Names of each record | Description |
|---|---|
| STUDIES | A study may be accomplished at any time to assist |
| UsePrerequisite | in decision making by users or processes of |
| StudyId (similar to GroupId) | BCTMS 101. For example, registration of users |
| StudyFormId (similar to GroupPurposeFormId) | may be dependent upon nomination of user profile |
| StudyStatedValue (similar to | information; or allowing a particular capacity to |
| GroupPurposeStatedValue) | be auctioned may be dependent upon nomination |
| ValidationPrerequisite | of a specification of the capacity, formation of an |
| NominationPrerequisite | appropriate group of qualified bidders, and |
| | achievement of a sufficiently large enough |
| | membership in the bidders group to facilitate an |
| | auction. |
| | The StudyStatedValue may describe the subject of |
| | the study, what is expected in the results, who is |
| | qualified to perform the study, and other suitable |
| | details to facilitate performing a study of |
| | conventional accuracy (such as how to |
| | corroborate a user stated value, how to perform a |
| | market survey, how to conduct a technology risk |
| | assessment, how to complete an international |
| | business forecast, etc). |
| STUDY_FORMS | A study form defines what information is to be |
| UsePrerequisite | collected during the study. Any number of studies |
| StudyFormId | may be arranged in a hierarchy so that one study |
| StudyForm (in blank) | represents that all subordinate studies have been |
| StudyFormParameterNames | completed satisfactorily. For example, a |
| StudyFormParameterDescriptions | nomination prerequisite may refer to a suitable |
| ValidationPrerequisite | nomination prerequisite status of one or more |
| NominationPrerequisite | subordinate studies. |
| STUDY-FINDINGS | A finding is a data item discovered and supplied |
| StudyId | to meet a demand made in a study form. A study |
| FindingsId (similar to group MemberId) | may be nominated when all underlying findings |
| FindingsStatedvalue (similar to | are nominated (i.e. the ApprovalPrerequisite is |
| MemberStated Value) | satisfied). For example, if a user claims 100 Volts |
| ValidationPrerequisite | in a capacity specification, the study may |
| ApprovalPrerequisite (similar to nomination | determine (by analysis or test) that 105 volts is |
| prerequisite) | expected or was observed and that 105 volts is an |
| | acceptable variation from 100 volts. An auditor |
| | may approve the finding based on, for example, |
| | whether or not the analysis conforms to reason or |
| | the test was conducted with calibrated |
| | instrumentation. |
| RISK_ASSAY_RULES | Risk rules may be referred to from any |
| UsePrerequisite | prerequisite, group form, or study form (see |
| RiskRuleId | GROUP_PURPOSE_FORMS file, infra.). |
| RiskRuleAlgorithm | |
| NominationPrerequisite | |

Manage-evaluation-services process 314, using file group 344 of TABLE 7, assures that the following services are performed at suitable time intervals: (a) selecting a study appropriate for ascertaining the reliability of information entered by a user; (b) directing an appropriate study to a member of a group authorized to perform the study; (c) directing a user to state his or her findings according to nominated help texts and sequences of steps; (d) notifying an appropriate member of a group to review and approve findings resulting from the study; and (e) ascertaining whether a sufficient number of approvals for findings have been posted to complete a study.

Manage-evaluation-services process 314 cooperates with any other management process that solicits or obtains stated values that are subject to a NominationPrerequisite that makes reference to a study.

TABLE 8

| File Name and Field Names of each record | Description |
|---|---|
| GROUPS | Membership in a group may be used to satisfy one |
| UsePrerequisite | or more prerequisites (e.g., thereby granting |
| GroupId | access and authority in any of several contexts as |
| GroupLabel | controlled by the structure and other prerequisites |
| GroupPurposeFormId | of BCTMS 101). Group members may be the |
| GroupPurposeStatedValue | subject of automatic actions by the site, for |
| InitialMembershipPrerequisite | example, notifications by a managing process. |
| RetentionMembershipPrerequisite | A GroupPurposeStatedValue indicates the |
| ValidationPrerequisite | identity(ies) or value(s) associated with the |
| | GroupPurposeForm designating a particular group |
| | (e.g., for a buying group, the capacity GroupIds |
| | characteristic of this particular buying group may |
| | be specified). Validation prerequisites may |
| | include, for example, that the |
| | GroupPurposeFormId nomination is current. |
| | Groups may define system administrative |
| | functions and so permit such group member users |
| | to be authorized to perform any one or more |
| | system administration functions (e.g., ‘delete’ |
| | capability for long old messages). |
| GROUP_PURPOSE_FORMS | Group purposes may be implemented in general |
| UsePrerequisite | by obtaining successful nomination of a |
| GroupPurposeFormId | GroupPurposeForm and in particular by obtaining |
| GroupPurposeForm (in blank) | successful nomination of a particular stated value |
| GroupPurposeFormParameterNames | within the context of the form. |
| GroupPurposeFormParameterDescriptions | |
| NominationPrerequisite | |
| GROUP-MEMBER | Each record is a tuple of group and member |
| GroupId | identifications. In accordance with the group |
| MemberId | purpose, membership prerequisites may be |
| MembershipStatedValue | suitably satisfied by any information item of |
| | BCTMS 101, for example, a user (e.g., a |
| | registered user), an entity, a fungible capacity, a |
| | process, an algorithm, a group (e.g., a mailing list |
| | assembled as a list of groups), or any suitable mix |
| | of these in the same group. |

Manage-group-services process 316, using file group 346 of TABLE 8, assures that the following services are performed at suitable time intervals: (a) directing a suitable form to the user to obtain information related to a business capacity transaction; (b) receiving information provided by a user in response to a form and determining whether the information is valid with reference to a ValidityPrerequisite; (c) posting information related to a business capacity transaction for limited review by users who are members of a suitable group for completing a NominationPrerequisite; (d) posting information related to a business capacity transaction for limited review by users who are members of a suitable group for performing a study and/or approving findings; (e) permitting access to information related to a business capacity transaction in accordance with nomination of the information, wherein information is nominated by being accepted into membership of a group; and (f) allocating an access privilege in response to successful nomination of information.

Manage-group-services process 316 cooperates with all management processes, inter alia, by facilitating satisfaction of any prerequisite that includes a dependency on group membership. For example, information associated with registration of a user, when nominated to a suitable user group may satisfy a UsePrerequisite for other information maintained by BCTMS 101.

TABLE 9

| File Name and Field Names of each record | Description |
|---|---|
| INVITES_FOR_OFFERS | An invite corresponds to an advertisement. It |
| UsePrerequisite | does not serve as an offer; but solicits offers for |
| InviteId | the identified capacity. BCTMS 101 may |
| GroupId (of a standard capacity specification) | facilitate the creation of many specialty markets |
| MemberId (of a particular entity, date, | for a wide variety of business capacity |
| location, etc.) | transactions. Each capacity to be traded may be |
| InvitePostedDate | nominated so that its specification is subject to |
| StatedAvailabilityDate | study and approval. Fungible capacities may be |
| InviteText | members of the same group. |
| ValidityPrerequisite | |
| AUCTIONS | BCTMS 101 supports auctions as defined by |
| UsePrerequisite | standard specifications given in a group of |
| AuctionId | auctions. Consequently, the same kind of auction |
| GroupId (of an auction specification) | may be performed many times for different |
| MemberId (of a particular auction) | purposes. Any conventional type of auction may |
| StatusOfAuction | be specified in the GroupPurposeForm and |
| AuctionAnnouncementDateTime | StatedValues for such form. For example, |
| AuctionActualStartDateTime | binding or nonbinding (tutorial), and single or |
| AuctionActualCloseDateTime | double auctions may be specified. The subject of |
| TransactionId(s) (e.g., one or more | the auction may be specified in any suitable |
| AgreementIds resulting from the | manner including as a capacity (e.g., by GroupId |
| auction) | and MemberId), a list of capacities, or a list of |
| ValidityPrerequisite | lists of capacities. Capacities in the same auction |
| | may differ in any manner (e.g., differ only in date |
| | available within an acceptable range of dates, or |
| | in Entity within an acceptable geographical |
| | territory) or may be related to a project (e.g., a |
| | sequence of capacities optimal for geographical or |
| | labor purposes). |
| BIDS | An offer advanced in a 1-on-1 negotiated |
| UsePrerequisite | transaction is herein included as a type of bid. |
| BidId | Bids also include responses to conventional |
| UserId | request for bids and positions taken in any form of |
| EntityId | exchange (e.g., an auction). Bids may be effective |
| Amount | immediately (preferred) or at a future time. For |
| DateTimeEffective | example, bids may be contingent on a project |
| AuctionId | event or may be determined at a time after the bid |
| ValidityPrerequisite | was submitted when that bid was validated or |
| | another bid became invalid. |
| TRANSACTIONS | All transactions are documented by written |
| UsePrerequisite | agreement which may be in the form of a bill of |
| TransactionId | sale or may include license, limitations, and other |
| AgreementId | terms besides price, quantity, and delivery place |
| ValidityPrerequisite | and time. |

Manage-market-services process 318, using file group 348 of TABLE 9, assures that the following services are performed at suitable time intervals: (a) conducting a business capacity transaction in accordance with a nominated algorithm; (b) selecting a nominated algorithm for performing a business capacity transaction; (c) administering a business capacity transaction (e.g., a license agreement negotiation or an auction) by providing notices to users in accordance with a nominated group membership of the user; (d) assisting a user in evaluating responses to bids; and (e) administering a business capacity transaction by accepting nominated information from parties to that transaction (e.g., closing governed by a NominationPrerequisite having dependency on existence of an executed agreement as indicated when the agreement is successfully nominated into a suitable group).

Manage market service process 318 cooperates with Manage-foundation-services process 302 and other management processes 304-316 to facilitate evaluation of prerequisites and performance of consequences that bring into effect the business capacity transaction, for example: a license negotiation, a call for qualified suppliers of a capacity heretofore unknown to BCTMS 101, or a double auction that satisfies a prerequisite for initiation of a step in a project.

Business capacity transactions are facilitated, according to various aspects of the present invention, by utilizing the mechanics of group formation and nomination discussed above. A sequence of groups may be formed by users to introduce a new business capacity, promote private transactions concerning the new business capacity, and bring about auctioned trading in units of the new business capacity. Such a business capacity may be a material, mechanism or control for a step in a project as discussed above. An example sequence of group formations is discussed in TABLE 10.

TABLE 10

| GroupPurposeForm and Names for its | |
|---|---|
| Stated Values | Description |
| SYSTEM ADMINISTRATOR GROUP | Members of the System Administrators Group |
| UserId | may by default satisfy any UsePrerequisite, |
| Resumé | allowing unobstructed access for trouble shooting, |
| | maintenance, and unusual operations. The |
| | GroupPurposeForm for the group at left is |
| | originally part of BCTMS 101 and so does not go |
| | through the nomination process. Likewise, at |
| | least one member of this group is originally part |
| | of BCTMS 101. The stated values for this |
| | original member do not go through the |
| | nomination process. Thereafter, all further |
| | changes to this group purpose form (e.g., adding a |
| | field for native language) may be subject to |
| | nomination (e.g., by members of this group). All |
| | further candidates for membership may be subject |
| | to nomination (e.g., by members of this group). |
| INTERNATIONAL LENDERS GROUP | Entities that provide services to business |
| EntityId | management (e.g., banks, consultants, advertisers, |
| References | agents for mergers and acquisitions), upon |
| | meeting the qualifications required for nomination |
| | via a group purpose form, may join a group such |
| | as this one and be more easily located by users of |
| | BCTMS 101. A system manager may complete |
| | one or more steps to form a group such as this one |
| | that serves merely as an advertising medium for |
| | member entities. |
| CONFERENCE 001031153200 GROUP | A conference group (e.g., a chat room) may be |
| UserId | formed as a group (e.g., by nomination which may |
| Reason for wanting to join | have available server capability as the only |
| | nomination prerequisite). Members of particular |
| | other groups may join by nomination (e.g., any |
| | registered user, any member of a particular |
| | interest group, etc.). The purpose of the |
| | conference may be to exchange ideas in any form |
| | (e.g., draft documents and clauses of agreements |
| | or standards in text; lab results or market research |
| | in graphics or animations; speeches or |
| | presentations on capacities, materials, controls, or |
| | mechanisms in video with audio). The topic of |
| | discussion may be announced by BCTMS 101 |
| | (e.g., by push technologies, or links on home |
| | pages) to attract candidates for membership. The |
| | conference may have a designated facilitator who |
| | performs one or more steps in nomination of new |
| | members into the conference. |
| CAPTAIN'S GROUP FOR PLASTICS | When a system administrator notices that interest |
| MANUFACTURING | in a particular step of manufacturing may be |
| UserId | sufficient to organize groups for managed |
| Employers | transactions, the system administrator may define |
| Employers Stock Value During Employment | the group purpose form for a Captain's Group of |
| Products, Volume, and Market Performance | the type at left. The system administrator may |
| | nominate the charter members and then give them |
| | authority to nominate others into the group. The |
| | group may operate according to bylaws prescribed |
| | by the system administrator. Such bylaws may be |
| | revised by the group, possibly with a system |
| | administrator having investigating or auditing |
| | authority to review nomination of the revised |
| | bylaws. |
| INTEREST GROUP FOR SURGICAL GLOVE | A Captain's Group as discussed above may have |
| FABRICATION | authority to nominate a group purpose form for an |
| UserId (promoting this candidate) | interest group such as the one at left. For |
| EntityId | example, a member of this Captain's Group may |
| Number of employees | be needed for approval of a study to which |
| Output in engineering hours per day | nomination of the group purpose form of the |
| References | Interest Group depends. Alternately, a system |
| | administrator may complete one or more steps of |
| | the nomination process for types of groups that |
| | merely exchange information without economic |
| | impact. After nomination of a suitable number of |
| | members into an Interest Group, industry |
| | standards may be proposed and discussed, |
| | resulting in formation of other groups (e.g., |
| | GroupPurposeForm nomination for any group |
| | discussed below). Entities not members of the |
| | Interest Group may contact group members to |
| | complete transactions not managed by BCTMS |
| | 101. |
| INVESTIGATORS GROUP FOR SURGICAL | Members of an Investigators Group may serve as |
| GLOVE FABRICATION | investigators in the nomination of members or |
| UserId | nomination of group purpose forms. Formation of |
| | an Investigators Group may be initiated by a |
| | member of a Captain's Group, Interest Group, or |
| | System Administrators Group. Nomination of the |
| | group purpose form may involve members of |
| | these groups (e.g., a majority of an Interest Group |
| | may be a prerequisite to nomination of a particular |
| | member into the Investigators Group). |
| | Investigators may receive automatic notice of and |
| | complete findings for a study. For example, |
| | nomination prerequisites for findings and for |
| | studies may refer to a suitable Investigators Group |
| | GroupId. |
| AUDITORS GROUP FOR SURGICAL GLOVE | Members of an Auditors Group may serve as |
| FABRICATION | auditors in the nomination of members or |
| UserId | nomination of group purpose forms. Formation of |
| | an Auditors Group may be initiated by a member |
| | of a Captain's Group, Interest Group, or System |
| | Administrators Group. Nomination of the group |
| | purpose form may involve members of these |
| | groups (e.g., a majority of an Interest Group may |
| | be a prerequisite to nomination of a particular |
| | member into the Auditors Group). Auditors may |
| | receive automatic notice of studies to be audited. |
| | For example, nomination prerequisites for |
| | findings and/or studies may refer to a suitable |
| | Auditors Group GroupId. |
| BIDDERS ON SUPPLYING SURGICAL | Authorization to supply a business capacity and |
| GLOVE FABRICATION | be a bidder in a particular transaction (e.g., 1-on-1 |
| UserId | deal, competitive bid, or auction) may each follow |
| | acceptance into suitable group membership via |
| | nomination as discussed above. A group of |
| | suppliers may aggregate capacity to provide in |
| | larger quantity or provide vertical leverage of a |
| | particular capacity (or list of capacities, or list of |
| | lists of capacities). Such a supply cooperative |
| | group may be a member of the group at left. |
| | Members of the Investigators and Auditors |
| | Groups discussed above may complete |
| | nomination prerequisites for the group purpose |
| | form for the group at left and nomination |
| | prerequisites for candidates for membership in the |
| | group at left. |
| BIDDERS ON CONSUMING SURGICAL | Authorization to use (consume) a business |
| GLOVE FABRICATION | capacity and be a bidder in a particular auction |
| UserId | may follow acceptance into suitable group |
| | membership via nomination as discussed above. |
| | A cooperative buying group (a mix of members |
| | amassing a large order) for quantity consumption |
| | or vertical leverage of a particular capacity (or list |
| | of capacities, or list of lists of capacities) may be |
| | accepted as a member of a suitable BIDDERS ON |
| | CONSUMING group similar to the group at left. |
| | Members of the Investigators and Auditors |
| | Groups discussed above may complete |
| | nomination prerequisites for the group purpose |
| | form for the group at left and nomination |
| | prerequisites for candidates for membership in the |
| | group at left. |
| CAPACITY OF SURGICAL GLOVE | Members of the Captain's Group, the |
| FABRICATION | Investigators Group, and the Auditors Groups |
| MemberId | discussed above may complete nomination |
| Capacity Stated Values | prerequisites for the group purpose form for the |
| | group at left and nomination prerequisites for |
| | candidates for membership in the group at left. A |
| | new business capacity group may be formed |
| | without direct involvement of a member of the |
| | System Administrator's Group. Candidates for |
| | membership are not entities; but may be for |
| | example quantities of the business capacity called |
| | “surgical glove fabrication”. Quantities that are |
| | members of this group may be traded |
| | anonymously (e.g., by market hedgers), in 1-on-1 |
| | deals, or by auction if named in an auction as |
| | discussed below. In addition to the quantity, any |
| | other parameters may be provided in |
| | CapacityStatedValues (e.g., delivery date, |
| | parameters peculiar to this particular incidence of |
| | the capacity, etc.). Parameters may be values that |
| | are within an allowable range defined in the |
| | nominated specification (e.g., membership GPF). |
| | The particular values of such parameters may |
| | affect the value of the capacity. The MemberId |
| | distinguishes among multiple capacities |
| | concurrently in the same group. |
| AUCTION GROUP FOR SURGICAL GLOVE | This group may be formed by cooperating |
| FABRICATION | members of the System Administrators Group, the |
| GroupId (of the business capacity group) | Captain's Group, the Investigators Group, and the |
| MemberId | Auditors Groups as discussed above. Members of |
| AuctionProcessId | the group at left are nominated from the business |
| | capacity group, for example, CAPACITY OF |
| | SURGICAL GLOVE FABRICATION, discussed |
| | above. In other words, particular capacity |
| | quantities may be nominated to be auctioned |
| | according to a nominated auction procedure |
| | associated with an AuctionProcessId. Nomination |
| | may be controlled by members of the |
| | Investigators Group and the Auditors Group as |
| | discussed above. |

Access to information about groups may be limited by group membership dependencies in UsePrerequisites associated with files, messages, reports, or queries referring to a particular group. For example, viewing a group purpose form for a business capacity group may be limited to current members of a related Interest Group; for a group that is expanding membership, viewing of the status of nomination into membership, of the identity and other descriptions of current members, and of statistics formed from such information may be limited to current members of the expanding group. Some status, identities, descriptions, and statistics may be given wide accessibility to encourage candidates to join relevant groups.

Information may be derived from node data 116 for display to users according to various aspects of the present invention. For example, page elements may include field values, records, results of queries, or reports of the type generated by a conventional database manager. Page elements (e.g., links or CGI commands) may be selectively provided on pages that are accessible to a user.

For example, a user's home page may be expanded to include a link to a page defined by a System Administrator for providing information to members of a particular group when nomination of membership for the user in the group is accomplished successfully. For example, a member of a bidder group may view on such a page a list and summary of all positions taken (bids, options, bids or options currently being considered, etc.). BCTMS 101 may assure that nomination of a new position depends on not exceeding a maximum of positions (number or value) already taken (or due within a predetermined period of time) using prerequisites and consequences as discussed above.

As another example, information describing a user may be requested on a group purpose form for which the user supplies stated values. However, the contents of a group purpose form may be provided in response to various links or queries and formatted as page elements. Because page elements have UsePrerequisites, access to confidential information (e.g., alleged misdeeds, true identity, other group memberships) may be restricted. For instance, a President of an Interest Group may have automatic access (e.g., as a result of current bylaws implemented with ConsequenceAlgorithms to nomination prerequisites) to the stated values for nationality, business address, and residence city and state; whereas, other group members may not.

Any system privilege may depend on UsePrerequisites that may be implemented as page elements as described above selectively provided on pages accessible to a particular user. For example, all necessary access privileges for completing a broadcast notification to all members of a group may or may not be available to each member of a group. As another example, the ability of a user to conduct a search for records matching various criteria may be restricted or not supported at all. Page elements may implement a search of predetermined files, predetermined fields, predetermined search algorithms, and/or predetermined search criteria.

User descriptors and tuples with UserId may be entered into additional files similar to ENTITY_DESCRIPTORS file and ENTITY-ENTITY_DESCRIPTORS file discussed above with reference to file group 338 and TABLE 4. In the preferred implementation, however, information describing a user is entered as stated values in a group purpose form that is validated and nominated prior to membership in a user group (e.g., registered users). Other group memberships may demand different disclosure from a user (e.g., whether or not the user is an “accredited investor” under the tax law of the United States). By accepting user information as membership stated values, BCTMS 101 assures nomination of information by skilled investigators and experienced auditors.

Use of system 100 for hosting auctions of a business capacity may proceed according to the steps listed below. Steps may be repeated or performed in any suitable order. Each user may perform its role in the following process in one or more sessions.

1. Form a group G10 for registered users wherein:

a. Membership criteria requires an applicant to supply a name and an email address

b. Nomination requires a system administrator to investigate and provide findings as to the authenticity of the name and email address and to produce findings

c. Nomination is automatic on existence of valid findings (i.e., no audit required)

2. Form a group G11 for registered entities wherein:

a. Membership criteria requires an applicant to supply a name of the entity, at least one registered user as an agent of the entity authorized to make binding commitments on behalf of the entity

b. Nomination requires a system administrator to investigate and provide findings as to the authenticity of the entity name, its financial status, the relationship between the registered user and the entity, and produce findings

c. Nomination requires a system administrator to audit the findings and approve acceptable findings for nomination

3. Form a group G12 for a conference wherein:

a. Membership criteria requires an applicant to be a registered user

b. Nomination is automatic on validation of applicant as a registered user

4. Attract prospects to apply for membership in groups G10, G11, and G12 using any advertising or network communication technique

5. Accept new members to group G10—registered users

6. Accept new members to group G11—registered entities

7. Accept new members to group G12—conference participants

8. Assist members of the group G12 to organize a captains group from among their own members, the captains group G14 having:

a. Membership criteria defined by members of group G12

b. Initial membership (not required to be nominated) of group G14 to include:

(1) At least one membership investigator for group G14

(2) At least one membership auditor for group G14

(3) At least one proposal investigator

(4) At least one proposal auditor

9. Attract applications for membership in group G14

10. Accept new members to group G14

11. Assist members of group G14 to propose and nominate (by action of the proposal investigator and proposal auditor):

a. At least one business capacity description for a business capacity that is expected to be traded, an applicant for membership must state a registered entity name and describe the business capacity within allowable limits in terms that the captains group members believe to be commercially reasonable

b. At least one buyers group membership criteria

c. At least one auction procedure defining the contractual supply obligations of entities related to business capacity being auctioned and contractual payment obligations of winning bidder of group G50.

12. Form a group G40 for business capacities wherein

a. Membership criteria is defined by the nominated business capacity description of step

11. Membership allows advertising of the supply of “qualified” business capacity to recognized standards as set by members of group G14.

b. Nomination of a business capacity requires investigation and audit for example by members of group G14

13. Form a group G50 for buyers of the business capacity of group G40

a. Membership criteria is defined by the nominated buyers group membership criteria of step 11

b. Nomination to membership requires investigation and audit for example by members of group G14 or their delegees

14. Attract registered users to make business capacity applications for membership in group G40 and group G50 using any advertising or network communication technique. A registered user who develops a project having a requirement for the business capacity of group G40 may be invited to become a member of group G50 to obtain the business capacity according to his project criteria (including, e.g., delivery quantity and schedule).

15. Accept new members to group G40—business capacity to be traded

16. Accept new members to group G50—buyers of business capacity nominated into group G40

17. Form an auction group G42 wherein:

a. Membership criteria require the business capacity being auctioned to be a member of group G40

b. Nomination requires investigation and audit that the business capacity is indeed available at the time to be auctioned. Investigation and audit may be accomplished, for example, by members of group G14 or their delegees

18. Conduct auctions of capacities that are members of group G42 to buyers that are members of group G50. At close of bidding the member of group G42 that was sold may be removed from group G42 and perhaps replaced by another member of group G40 as desired. Auctions to be conducted according to the nominated auction procedure of step 11.

19. At any time allow conference members of group G12 (which includes supplying entities and buyers) to discuss and offer suggestions to captains group G14 regarding changes to membership criteria for groups G40 and G50 over which captains have jurisdiction and to auction procedures used in auctions involving groups G40 and G50.

20. Without confusing ongoing transactions, allow captains group G14 to revise and nominate new membership criteria for groups G40 and G50 and auction procedures.

Operation of a system for managing a business capacity transaction may include facilitating accomplishment of users' objectives including, inter alia: (a) signing-on to gain access to information related to a business capacity transaction; (b) registering an entity so that actions by particular users bind the entity to a business capacity transaction; (c) facilitating membership by users in groups having purposes defined by the users; (d) facilitating approval of information describing a business capacity by facilitating creation of a group having a nominated purpose related to the description of the business capacity and facilitating nominated membership in such a group by a particular business capacity; (e) developing a graph of business capacity transactions related by prerequisites including satisfaction of commitments; and (f) presenting information and conducting business capacity transactions in accordance with a graph of business capacity transactions.

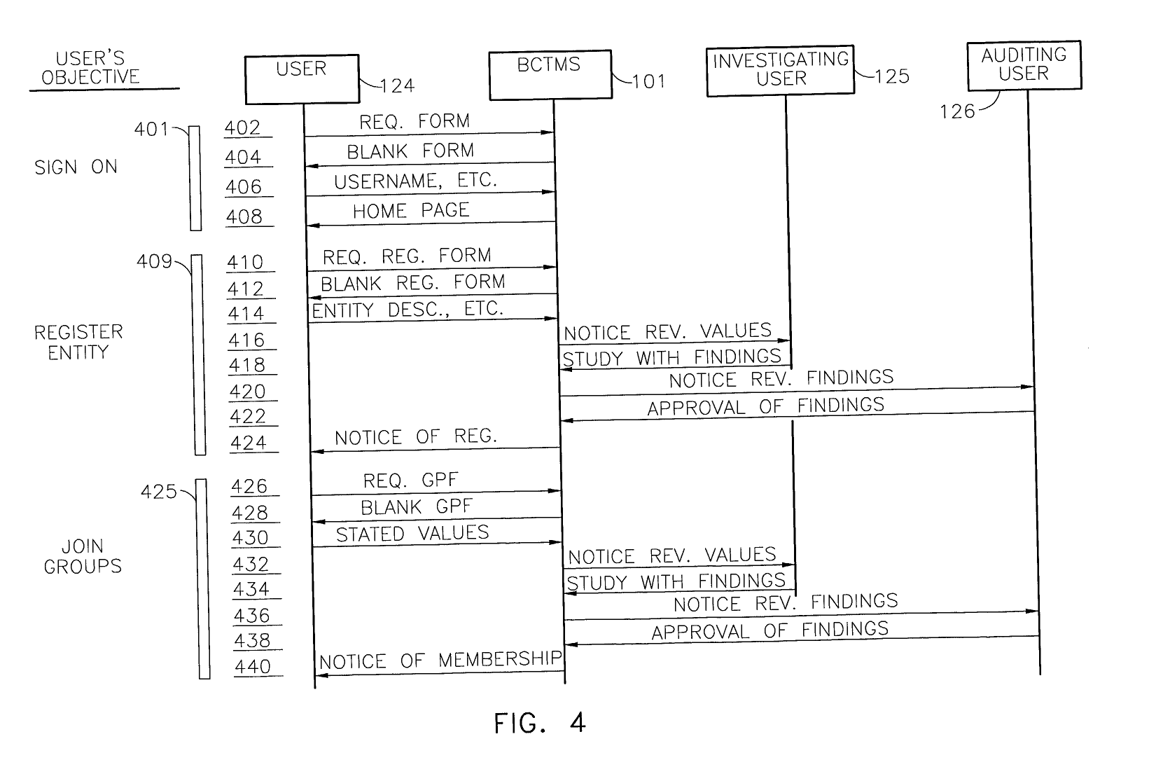

A method of signing-on to a business capacity transaction management system according to various aspects of the present invention includes obtaining information selected by the user in response to the user filling in a form. For example, method 401 of FIG. 4 for signing-on to BCTMS 101 includes the following steps.

User 124 makes a request to receive a sign-on form from BCTMS 101 (step 402). For example, user 124, with knowledge of a World Wide Web site Uniform Resource Locator (URL), may operate Browse process 142 to demand that a page at that URL be provided to client 104 via network 103. A suitable blank form is selected by BCTMS 101 and provided to user 124 (step 404).

Selection may be accomplished as follows: (a) Communicate process 110 (FIGS. 1 and 3D) directs the demand (e.g., a command in HTTP) to Manage-foundation-services process 302. Process 302: determines that the command has arrived at a server matching a record in SERVERS of file group 332; creates a record in SESSIONS of file group 332; and creation of the record in SERVERS may satisfy a prerequisite in PREREQUISITES of file group 332 having a predicate that identifies that a predetermined page be sent. The page that is sent may be a group purpose form (GPF) from a suitable group. By providing a GPF, as opposed to a fixed page defmed by a system administrator, new forms for signing-on may be nominated by users.

In response to receiving the selected page, Browse process 142 or 202 may present the page to the user; accept user input for the information requested on the form (e.g., username, password); and send the user-provided information back to BCTMS 101 (step 406). A suitable home page is then provided by BCTMS 101 (step 408), completing the signing-on method. The response page may: (a) welcome an unregistered user and provide links to pages accessible to an unregistered user; or (b) welcome a registered user (i.e., having a UserId recognized as being a member of a group herein called Registered Users Group, discussed below) and provide links to pages to which the registered user has access privileges in accordance with any groups to which the user's membership information has been nominated (i.e., the user is a current member).

In response to receiving information from the sign-on page, Communicate process 110 may direct such information to Manage-member-services process 338. Process 338 may: identify the UserId from USER-ENTITY of file group 338; and determine the home page from PageId in USERS of file group 338. Upon reference to a username in USER-ENTITY, Manage-foundation-services process 302 in cooperation with other management processes (304-318) may by operation of an algorithm in CONSEQUENCES of file group 332: determine the user's related EntityId from file group 338; determine the user's account status from ACCOUNTS in file group 342 (and possibly limit access privileges accordingly); prepare a to-do list from a review of prerequisites pending action by the user (e.g., identified by UserId) or by the user as a consequence of membership in a group having pending responsibility (e.g., identified by GroupId) such as studies pending input from this user or findings pending approval by this user; prepare to transfer MESSAGES from file group 336 to which the UserId satisfies a suitable UsePrerequisite (e.g., owner, reader, reviewer, etc.) to user data 210 of client 104 (messages may include notices generated by BCTMS as predicate consequences of satisfied prerequisites); and determine the structure and presentation of information on the home page in accordance with information associated with the UserId from file group 334.

The signing-on method may continue in an alternate configuration to include signing-on to a conference. The method discussed above presumes a single user session. In response to the home page (step 408) or the blank form (step 404), the user may provide information that identifies a GroupId for a conference. A mechanism for joining an available conference (e.g., a list from which the user may designate a selection) may be provided on the sign-on page (general interest conferences) or on the home page (including potentially confidential conferences).

A method of registering an entity so that actions by particular users bind the entity to a business capacity transaction according to various aspects of the present invention includes nomination of information describing the entity. For example, method 409 of FIG. 4 for registering an entity with BCTMS 101 includes the following steps.

Registration of an entity may be accomplished by successful nomination to membership of the entity in a group of entities herein called Registered Entities Group. The registration of a user may be accomplished in a similar manner by successful nomination to membership of the user in a group of users herein called Registered Users Group (see method 425 discussed below). Successful nomination to membership of a group, according to various aspects of the present invention, includes obtaining approval of findings that correspond to stated values provided by a user (e.g., on a group purpose form).

A user with access to a current page having a link or with knowledge of a URL (and any suitable key-value pairs) may indicate a desire to register an entity by activating the link or demanding the appropriate URL (step 410). Communicate process 110 acts on the demand (e.g., an HTTP command or an interprocess communication determined in response to an HTTP command) by passing information to Manage-group-services process 316. Process 316 obtains a group purpose form in blank from GROUP_PURPOSE_FORMS and GROUPS of file group 346 with reference to GroupLabel (e.g., equal to “Registered Entities Group”) and GroupPurposeFormId. The group purpose form may be blank or include nominated information associated with the group. In the later case, process 316 supplements the blank form by using the GroupId or GroupLabel to obtain GroupPurposeStatedValue from GROUPS. Presumably, the identified group purpose form and GroupPurposeStateValue have been nominated and is therefore available for this use as indicated by UsePrerequisite having a dependency on “any user” or having no more restrictive dependency related to the current UserId (e.g., a black-listed UserId). Processes 304 and 110 then send the identified page and consequences (if any) are performed by process 302.

Information supplied by a user is herein referred to as one or more stated values. A stated value is not necessarily reliable for purposes of managing a business capacity transaction. To assure accuracy (e.g., reduce typographical error, puffing by advertisers and entrepreneurs, and fraud), BCTMS 101 distinguishes a stated value that has not been reviewed from a stated value that has been successfully reviewed by associating with the stated value (e.g., in the same record or a parent record) a NominationPrerequisite. A stated value is considered nominated (i.e., the information or corresponding user, entity, capacity, or group member is nominated) when all associated NominationPrerequisites are currently satisfied (e.g., a one time satisfaction may be latched to avoid inefficient re-evaluations). Node data 116 includes information as stated values (e.g., permitting review and discussion) and as nominated. After a stated value has been nominated, the information it represents is considered sufficiently reliable in relation to a purpose. The related purpose may be described on or implied from the content (or use by BCTMS) of a group purpose form on which the stated value was entered.

User 124 supplies information to fill in the blank group purpose form and sends the information to BCTMS 101 (step 414). Information received from a user is stored as stated values. For example, information could be requested for the legal name of the entity, the names of its officers, the contents of its latest annual report, and its current physical address. Of course, since the group purpose form in blank was nominated, the information requested may conform to any standard of commercial reasonableness held by the users that participated in nomination. Therefore, if it is deemed desirable in the future to request other information, the group purpose form requesting information may be modified and re-nominated. (As a practical matter, a new GroupId may be created and the old GroupId maintained while the new group purpose form is considered for nomination.) On receipt of information supplied in response to a group purpose form, Manage-group-services process 316 may create a unique MemberId, create a record in GROUP-MEMBER of file group 346 and store the MemberId and received information as MemberStatedValue in the created record.

As a consequence of posting a new record in GROUP-MEMBER, BCTMS 101 may notify relevant users to perform an investigation of the stated values (step 416). Of course in some cases little or no investigation may be desirable (e.g., minor revision to existing entity registration). Notification may be implemented as follows: the ValidationPrerequisite in the new record in GROUP-MEMBER (e.g., spelling verified and no blank form fields) may include a predicate consequence. Manage-foundation-services process 302 may perform the identified consequence algorithm in CONSEQUENCES of file group 332. The consequence algorithm may analyze the NominationPrerequisite in the new record in GROUP-MEMBER to develop a list of BoxIds, UserIds, EntityIds, and/or GroupIds to notify. Manage-mail-services process 306 may distribute a parameterized form message in accordance with the list.

The form message may identify or facilitate access to a suitable study (i.e., provide a suitable StudyId). One or more StudyIds may be included in GroupStatedValue of the record identified by GroupId in GROUPS. Alternate StudyIds may provide information appropriate for a particular investigator (e.g., investigator responsible for only some of the stated values, investigator may prefer the study in a particular language).

A user notified to conduct a study reviews stated values (e.g., that the entity's officers exist by obtaining a telephone interview with each officer) and determines findings (e.g., the date and time that the telephone interview was conducted successfully) (step 418). Findings stated values may also be subject to review. BCTMS 101, on receipt of a valid study (e.g., complete as to the fact that all requested findings were made), may notify one or more users (step 420) that findings are available to review in a manner similar to the manner in which notifications were distributed with reference to step 416.

User 126 may review findings, discuss findings in a discussion (e.g., participate in DISCUSSIONS), request a new study or new findings, note that findings will not be approved, and may approve findings. The approval of findings (step 422) may be accomplished by the auditing user 126 traversing a link or providing a suitable stated value. BCTMS recognizes approval of findings sufficient for nomination of the study and when the study NominationPrerequisite is satisfied, may provide notice to user 124 (step 424) that registration of the entity was successful (i.e., the entity is a member of Registered Entities Group). For convenience, of access, nominated information about an entity may be copied or moved by BCTMS to files in group 338.

Nomination of the auditing user's stated value is generally not desirable because auditing user 126 has been nominated into membership of a group whose group purpose form included request of credentials deemed appropriate when the auditing group purpose form was itself nominated by relevant users.

A method for facilitating membership by users in groups having purposes defined by the users according to various aspects of the present invention includes nomination of information describing the user. For example, method 425 of FIG. 4 for facilitating membership in a group managed by BCTMS 101 includes the following steps. Steps 426 through 440 correspond respectively with steps 410 through 424, discussed above. When the user is nominated to the Registered Users Group, information from the nominated group purpose form may be copied or moved by BCTMS 101 to files of file group 338 for convenience of access.

Note that InitialMembershipPrerequisite and RetentionMembershipPrerequisite in the GROUPS file may be evaluated for each member by parametric substitution from MemberStatedValue of a particular MemberId in GROUP-MEMBER.

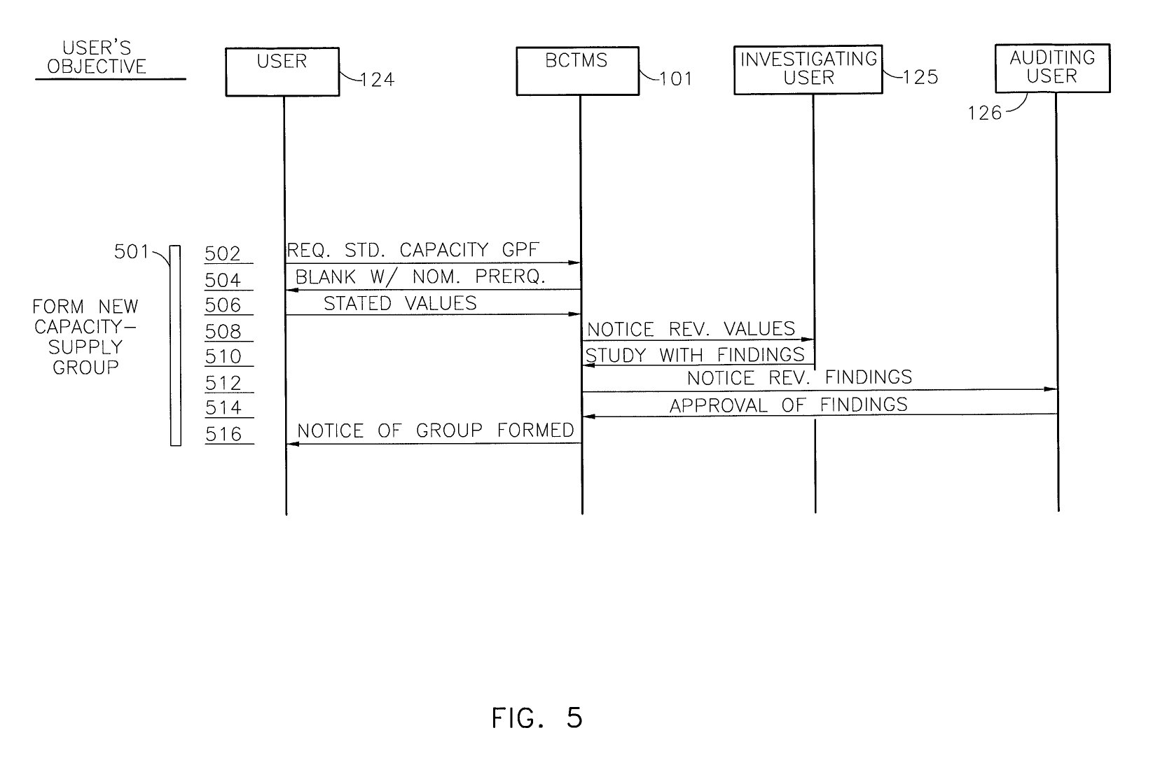

A method for facilitating approval of information describing how to specify a business capacity, according to various aspects of the present invention, includes creation of a group having a nominated purpose related to specification of the business capacity. For example, method 501 of FIG. 5 by which BCTMS 101 facilitates such approval includes the following steps. Steps 502 through 516 correspond respectively with steps 410 through 424, discussed above except as discussed below. In this case the nomination is of the group purpose form itself in blank. Although the nomination mechanism is the same as discussed above, the subject NominationPrerequisite is that which is stored in the record of the blank form in GROUP_PURPOSE_FORMS of file group 346. The group purpose form of a business capacity may correspond in information content to an advertisement or specification (e.g., a data sheet) of the underlying service. By subjecting the group purpose form to nomination, industry norms may be followed in the adoption of unforeseen business capacities without participation of a system administrator of BCTMS 101. For example, a new business capacity may be nominated as a satisfaction of a NominationPrerequisite having a dependency on receiving approved findings by a majority of members of an industry specific user group (e.g., a user group of GROUPS wherein each member has been successfully nominated to membership). Any number of relevant aspects of a proposed business capacity may be added, deleted, or revised during the process of obtaining nomination as deemed desirable by users involved with the nomination process in some way. Involvement may be limited to participation in DISCUSSIONS without having access to the full group purpose form being considered. For example, portions of the form (e.g., page elements or tagged items in XML) may be identified as messages for discussion.

Information describing a business capacity may be copied or moved at any time by BCTMS 101 from the nominated group purpose form to files of file group 338 for convenience of access.

User 124 may provide information describing an entity and/or a business capacity in response to any form supplied by BCTMS 101. Such information may be posted in files of group 338 for convenient access and copied or moved by BCTMS 101 to any suitable group purpose forms for nomination as discussed above without further action being taken by user 124. Consequently, nomination of the user or an entity (e.g., to a group unknown to the user or to a position of honor) may be initiated by BCTMS 101. Nomination may proceed in confidence (UsePrerequisites being suitably limited). Notifications as in steps 424, 440, 516, and 614 may be delayed or made subject to intervention by a designated user on occurrence of a prescribed event (e.g., facilitating simultaneous notice to all nominated subcontractors of a contract award).

A method for facilitating approval of information describing a particular business capacity (e.g., as performed by a particular entity on particular future dates), according to various aspects of the present invention, includes nominated membership of the particular business capacity into a group having nominated membership criteria.

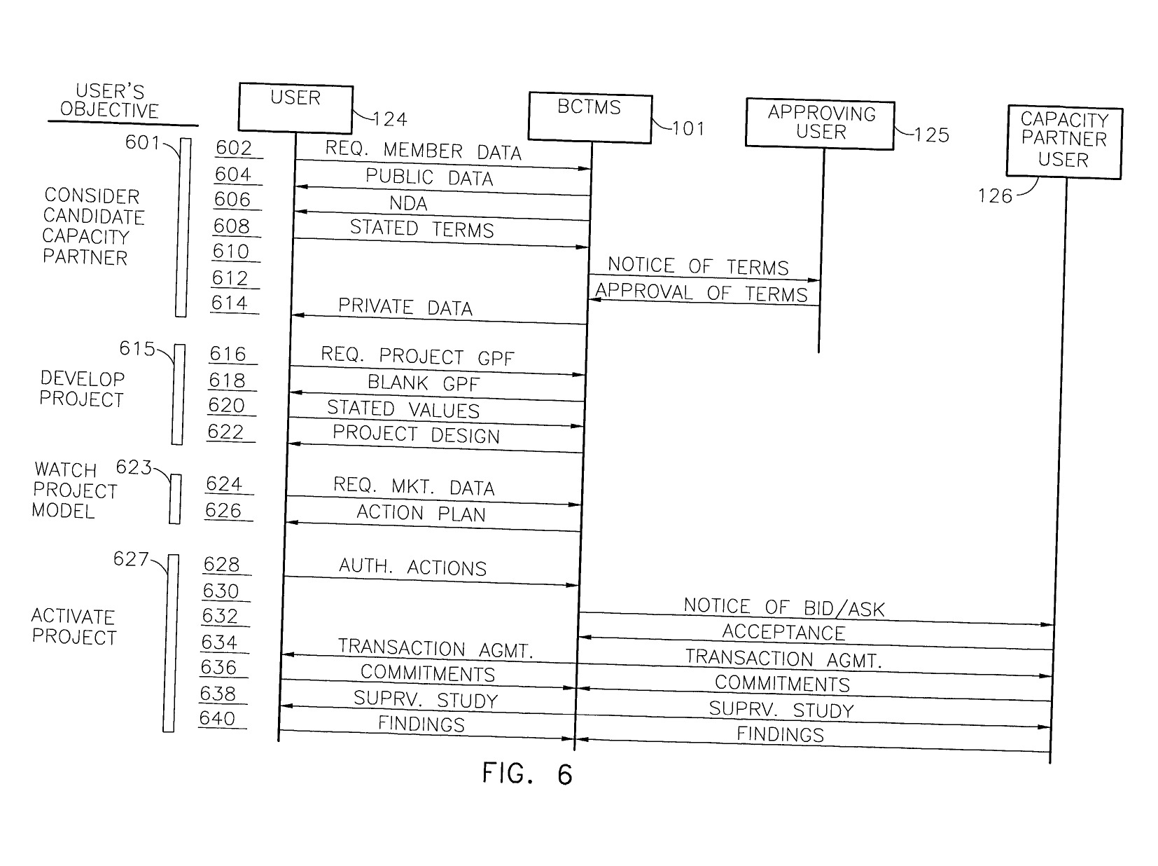

When an entity desires to seek candidate entities for the purpose of acquiring a business capacity from one of the candidates, the seeking entity may exchange information related to a business capacity transaction (e.g., procurement of the desired business capacity) according to a method of entering a business arrangement according to various aspects of the present invention. For example, method 601 of FIG. 6 by which BCTMS 101 facilitates entering into a business arrangement includes the following steps.

A registered user interested in a candidate entity may demand BCTMS provide information associated with a descriptor of the entity (step 602). The information provided by user 124 may be sufficient for a query of node data 116 by BCTMS 101. Results of the query (e.g., portions of records from ENTITY_DESCRIPTORS, ENTITY-CAPACITY-STATED_VALUE, ENTITY-PROJECT, ACCOUNTS, ARCHIVED_AGREE, GROUP-MEMBER, INVITES_TO_OFFER, TRANSACTIONS) may be provided (step 604) to the extent not limited by unsatisfied UsePrerequisites. BCTMS 101, in response to a consequence of a failed UsePrerequisite, may provide a group purpose form as if requested by user 124. Such a group purpose form when filled in with stated values that are then nominated, may accomplish the formation of an agreement for nondisclosure of information (i.e., that user 124 will not disclose the information to others). In other words, stated values may be received (step 608), notice of the submission of such terms may be provided to an authorized approving user 125 (step 610), and approval of the stated terms may be made by the approving user 125 (step 612) in a manner similar to notification and approval steps discussed above. If approved, BCTMS 101 may provide additional results of the query (step 614) now not limited by nonexistence of a suitable nondisclosure agreement.

A method for developing a graph of business capacity transactions, according to various aspects of the present invention, includes associating business capacity transactions with prerequisites including satisfaction of commitments. For example, method 615 of FIG. 6 by which BCTMS 101 facilitates developing such a graph includes the following steps. A project may be modeled by BCTMS as a mathematical graph (i.e., a network of nodes) wherein each node represents an aspect of one or more business capacity transactions. Each node may include one or more materials, controls, or mechanisms as discussed above. The provision of a material, performance of a control, or performance of a mechanism may be described with reference to any business capacity including business capacities currently being traded in markets managed by BCTMS. The occurrence of a business capacity in several projects by different entities may satisfy a prerequisite having a predicate consequence that notifies the relevant users and initiates the process of nominating the business capacity for participation in such a market.

To begin, user 124 requests a project group purpose form (616) and BCTMS 101 provides same (step 618). User 124 provides stated values (step 620) on the provided group purpose form and BCTMS 101 provides a project design description (step 622). As additional information is to be added to the project design, steps 616 through 622 may be repeated with reference to new or partially filled in group purpose forms. BCTMS may provide the project design in any conventional form (e.g., a milestone chart, Gant chart, waterfall chart, resource allocation plan, etc.). The project stated values may include reference to any information available in node data 116 including, for example, the market price of services identified to one or more steps of the project.

A method for presenting information in accordance with a graph of business capacity transactions, according to various aspects of the present invention, includes presenting information from a market wherein business capacity transactions are arranged. For example, method 623 of FIG. 6 by which BCTMS 101 presents business capacity information includes the following steps. User 124 may request market data regarding a project defined as discussed above. Some steps of the project may refer to business capacity transactions similar to transactions managed by BCTMS 101 (step 624). In response, BCTMS 101 may provide an action plan (step 626) that includes current market data on all nodes of a project (or forecast data for nodes related to times in the future).

A method for facilitating business capacity transactions in accordance with a graph of business capacity transactions, according to various aspects of the present invention includes conducting an auction to close a business capacity transaction and obtaining nominated information describing a result of the auction. For example, method 627 of FIG. 6 by which BCTMS 101 facilitates a business capacity transaction includes the following steps. To begin, user 124 may authorize one or more actions (e.g., business capacity arrangements including obtaining materials, performing controls, or providing mechanisms as discussed above) of the action plan discussed above (step 628). BCTMS may provide notice of a bid or ask related to the actions authorized (step 630). Notice may be delivered to one or more candidate business capacity partners 126 (whether or not known by user 124). Candidates 126 may be prequalified as being members of a group nominated to provide the relevant action. Candidates 126 may respond to notice with acceptance (or refusal, which may be implied from no response) (step 632). BCTMS 101 may then provide transaction agreements in blank for approval or further negotiation by the parties (step 634). When all necessary parties have made sufficient commitments (e.g., deposits to ACCOUNTS identified as in escrow for this transaction, and agreements executed for the purpose of this transaction), (step 636) the authorized action may proceed to closing (e.g., with further agreements managed by BCTMS or without reference to BCTMS). According to various aspects of the present invention, BCTMS may initiate a supervisory study by notice to the parties or related users (step 638). The study may produce finding and approvals as discussed above. A nominated supervisory study may provide information relevant to a DISCUSSION, or nomination of group purpose forms for the business capacity, entities, industry groups, or users related to the business capacity, transactions, agreements, or commitments.

When a plurality of bids is received for a step of a project or for an action plan as a whole, BCTMS may, according to various aspects of the present invention, assist the user in selecting a bid from the plurality of bids. For example, bids received as set forth in TABLE 11 are analyzed with a resulting group of files as described in TABLE 12. A record is prepared by interpreting each response to form a record. Such interpretation may be done by a human investigator or by a process. A bid comparison report presenting these findings has page elements as described in TABLE 13. In TABLE 13, the bid having nonconformities with the least economic significance is identified as a probable “best choice” bid of the plurality.

TABLE 11

| Page Elements in Presentation of Bids | Description |
|---|---|
| SPECIFICATION | A simple specification for surgical gloves. The |
| :: 1.0 Gloves of material latex with thickness 7 mm | rank and weight of each specification paragraph is |
| +/− 1 mm. | not known to the bidders. |
| :: 2.0 Color white. | |
| :: 3.0 Deliveries | |
| :: 3.1 10,000 dozen on or before June 1. | |
| :: 3.2 12,000 dozen on or before July 1. | |
| :: 3.3 8,000 dozen on or before August 1. | |
| :: 4.0 Total cost less than $0.05 per pair | |
| IDENTIFICATION | This bid provides better uniformity of thickness |
| :: A CO. | than required. This bid does not comply with color |
| RESPONSE | or price. Higher quantities are shipped earlier. |
| :: 1.0 latex 6 mm +/− 0.5 mm. | |
| :: 2.0 yellow. | |
| :: 3.1 12,000 by May 29. | |
| :: 3.2 12,000 by June 29. | |
| :: 3.3 6,000 by July 15. | |
| :: 4.0 $0.05 per pair | |
| IDENTIFICATION | This bid is fully compliant. The amount that the |
| :: B CO. | price is below $0.05 per pair may be a factor. |
| RESPONSE | |
| :: 1.0 latex 7 mm +/− 1 mm. | |
| :: 2.0 white. | |
| :: 3.1 10,000 by June 1. | |
| :: 3.2 12,000 by July 1. | |
| :: 3.3 8,000 by August 1. | |
| :: 4.0 $0.0499 per pair | |
| IDENTIFICATION | This bid provides better uniformity of thickness |
| :: C CO. | than required and provides a better price than the |
| RESPONSE | requirement. It is not compliant with color or |
| :: 1.0 latex 7.5 mm +/− 0.5 mm. | delivery schedule. Whether or not the |
| :: 2.0 light green. | noncompliance with schedule is an economic |
| :: 3.1 30,000 by June 1. | burden or benefit is not known to the bidder. |
| :: 3.2 0 by July 1. | |
| :: 3.3 0 by August 1. | |
| :: 4.0 $0.03 per pair | |

The bid comparison report was prepared from an intermediate file in accordance with the following guidelines.

TABLE 12

| File Name and Field Names of each record | Description |
|---|---|
| RANKING OF REQUIREMENTS | Request for quotation (RFQ) identifies the record |
| RFQ_ID | for purposes of reporting a bid comparison. By |
| specification paragraph number | defining a rank for each paragraph of the |
| rank (e.g., weight) | specification (including schedule), the weighted |
| | nonconformance can be determined and |
| | nonconformance may be described from the most |
| | significant nonconformities (e.g., having the highest |
| | weighted nonconformance) in order to the least. |
| | The resolution of weights may be subject to |
| | nomination of the study as discussed above. An |
| | industry standard ranking and weighting may be |
| | used. The industry standard ranking and weighting |
| | may be developed by BCTMS 101 on analysis of |
| | bids in similar transactions (e.g., when the same |
| | specification has been used in several transactions). |
| | HELP topics may be developed to explain system |
| | variation as it maintains averages and normative |
| | values. |
| IDENTIFICATION | The identification may be omitted from pages to be |
| RFQ_ID | reviewed objectively. |
| Name of company submitting the bid | |
| SPECIFICATION | Each paragraph having a deviation (good or bad) |
| nonconforming paragraph | from the specification is the basis for a record in |
| extent of nonconformance | this file. The extent of nonconformance and extent |
| economic consequence of nonconformance | of exceeding the requirement may be stated as a |
| paragraph where proposal exceeds requirement | negative number for nonconformance and a |
| extent of exceeding requirement | positive number of exceeding requirement. |
| economic benefit for exceeding requirement | Nonconformance may be masked by exceeding |
| | performance in other areas. Masking among |
| | economic consequence and benefit may be |
| | permitted while masking among technical |
| | requirements may be avoided (e.g., disabled). |
| | The order of presentation of paragraph numbers |
| | may be according to the product of economic |
| | consequence (or benefit) and weight. |

TABLE 13

| Industry Std | Requirement | Economic Weight |
|---|---|---|
| Latex thickness | latex thickness | +$0.005 for thicker; −$0.007 |
| 8 mm +/− 2 mm | 7 mm +/− 1 mm | for thinner |
| Light yellow | white | not significant |
| Fewest deliveries | 10,000; 12,000; | Early delivery penalty of +$0.04 |
| in even amounts | 8,000 | because no storage. Late deliveries |
| | | penalty $0.10 |
| Cost $0.06/pair | less than | apply cost differential as weight |
| | $0.05/pair | |

Table 14 illustrates a result of applying economic weights of Table 13 to the bids of Table 11, wherein the bid from CO. A is determined to be lowest and hence, most preferred.

TABLE 14

| Paragraph | CO. A | CO. B | CO. C | Comment |
|---|---|---|---|---|
| 1.0 | −0.007 | 0 | 0 | There is a benefit to A because A's gloves |
| | | | | can be thinner than the specification -- A's |
| | | | | tolerance at a minimum produces gloves at |
| | | | | 5.5 mm. |
| 3.1 | 2/30* + 0.04 = | 0 | 18/30* + 0.04 = | A's and C's bids are burdened pro rata by |
| | +0.003 | | +0.024 | early delivery of a portion of the total |
| | | | | quantity for which storage costs will be |
| | | | | incurred. |
| 3.2 | 0 | 0 | 0 | |
| 3.3 | 0 | 0 | 0 | |
| 4.0 | 0 | −0.001 | −0.020 | Lower prices are recognized as a benefit. |
| Total | −0.004 | −0.001 | +0.004 | |

The foregoing description discusses preferred embodiments of the present invention which may be changed or modified without departing from the scope of the present invention as defmed in the claims. While for the sake of clarity of description, several specific embodiments of the invention have been described, the scope of the invention is intended to be measured by the claims as set forth below.

What is claimed is:

1. A method for auctioning a business capacity, the method comprising:
forming a first group for registered users wherein membership criteria requires an applicant to supply a name and an email address; nomination requires a system administrator to investigate and provide findings as to the authenticity of the name and email address and to produce findings; and nomination is automatic on existence of valid findings;
forming a second group for registered entities wherein membership criteria requires an applicant to supply a name of the entity, at least one registered user as an agent of the entity authorized to make binding commitments on behalf of the entity; nomination requires a system administrator to investigate and provide findings as to the authenticity of the entity name, its financial status, the relationship between the registered user and the entity, and produce findings; and nomination requires a system administrator to audit the findings and approve acceptable findings for nomination;
forming a third group for a conference wherein membership criteria requires an applicant to be a registered user; and nomination is automatic on validation of applicant as a registered user;
attracting prospects to apply for membership in the first, second, and third groups using network communication;
accepting new members to the first, second, and third groups;
assisting members of the third group to organize a fourth group from among members of the third group, the fourth group having membership criteria defined by members of the third group; initial membership of the fourth group to include at least one membership investigator, at least one membership auditor, at least one proposal investigator, and at least one proposal auditor;
attracting applications for membership in the fourth group;
accepting new members to the fourth group;
assisting members of the fourth group to propose and nominate by action of the proposal investigator and the proposal auditor at least one business capacity description for a business capacity that is expected to be traded wherein an applicant for membership must state a registered entity name and describe the business capacity within allowable limits in terms that the fourth group members believe to be commercially reasonable; at least one buyers group membership criteria; and at least one auction procedure defining the contractual supply obligations of entities related to business capacity being auctioned and contractual payment obligations of a winning bidder;
forming a fifth group for business capacities wherein membership criteria is defined by the nominated business capacity description; nomination of a business capacity requires investigation and audit by members or delegees of the fourth group;
forming a sixth group for bidders, wherein the fourth group includes the winning bidder; membership criteria is defined by the nominated bidders group membership criteria; nomination to membership requires investigation and audit by members or delegees of the fourth group;
attracting registered users to make business capacity applications for membership in the fifth group and sixth group using network communication;
accepting new members to the fifth and sixth groups;
forming an seventh group wherein membership criteria require the business capacity being auctioned to be a member of the fifth group; nomination requires investigation and audit that the business capacity is indeed available at the time to be auctioned; investigation and audit being accomplished by members or delegees of the fourth group;
conducting at least one auction of business capacities that are members of the seventh group to bidders that are members of the sixth group; wherein auctions are conducted according to the nominated auction procedure;
from time to time allowing members of the first group to discuss and offer suggestions to members of the fourth group regarding changes to membership criteria for the fifth and sixth groups; and
from time to time allowing members of the fourth group to revise and nominate new membership criteria for the fifth and sixth groups and for the auction procedure.
